(19) United States
(12) Patent Application Publication
(10) Pub. No.: US 2026/0079283 A1
(43) Pub. Date: Mar. 19, 2026

(54) Strong Angular-Responses By Using Ultra-Low Refractive Index Dielectrics In Optical Devices

(71) Applicant: The Regents of The University of Michigan, Ann Arbor, MI (US)

(72) Inventors: Lingjie Jay GUO, Ann Arbor, MI (US); Weijie FENG, Seattle, WA (US)

(73) Assignee: The Regents of The University of Michigan, Ann Arbor, MI (US)

(21) Appl. No.: 19/329,295

(22) Filed: Sep. 15, 2025

Related U.S. Application Data
(60) Provisional application No. 63/694,536, filed on Sep. 13, 2024.

(51) Int. Cl. G02B 1/115; G02B 1/116; G02B 1/118; G02B 5/20; G02B 5/22

(52) U.S. Cl. CPC G02B 1/115; G02B 1/116; G02B 1/118; G02B 5/207; G02B 5/223; G02B 2207/101

(57) ABSTRACT

The present disclosure contemplates an optical device that comprises a low refractive index layer that comprises a porous oxide material. The optical device may further comprise at least one additional layer comprising a second material. The optical device may comprise an ultra-low refractive index layer that comprises a porous dielectric material. Such a device may have strong angle-dependent spectral responses, including structural color devices that may produce highly iridescent and angle variable color output. In other aspects, a device is provided that comprises a first layer or region comprising a porous material comprising silicon dioxide (SiO₂), which may be an aerogel or formed via glancing angle deposition (GLAD). The device may also comprise at least one additional layer or region comprising a dielectric material or a metal.

### CROSS-REFERENCE TO RELATED APPLICATIONS

This application claims the benefit of U.S. Provisional Application No. 63/694,536, filed on Sep. 13, 2024. The entire disclosure of the above application is incorporated herein by reference.

### GOVERNMENT SUPPORT

This invention was made with government support under 2213684 awarded by the National Science Foundation. The government has certain rights in the invention.

### FIELD

The present disclosure relates to an optical device that includes an ultra-low refractive index material, for example, a dielectric material in the form of a porous aerogel. The optical device also has at least one additional layer, which can form a variety of optical devices having strong angle-dependent spectral responses, including structural color devices that exhibit highly iridescent colors.

### BACKGROUND

This section provides background information related to the present disclosure which is not necessarily prior art.

Multilayer thin film structures typically produce optical responses (e.g., transmission and/or reflection spectra) dependent upon the angle of light incidence. This is because not only the propagation phase inside each layer is angle-dependent, but also Fresnel reflection and transmission coefficients at each interface are both angle- and polarization dependent. Such effects can be exploited for different applications, e.g. angle-dependent spectrum filters, multilayer thin film-based mirrors, and the like. Iridescence, or changes in color with angle of observation, is an attractive optical phenomenon commonly found in nature. Insight into the microstructure of insect wings, bird feathers, and seashells shows that iridescence is enabled by thin film interference, a type of structural color: the interaction of light with layers of different refractive indices on a sufficiently small scale. This is impossible to achieve through chemical dye- or fluorophore-based methods, both naturally and synthetically. Thus, developing iridescent structural colors based on thin-film interference is of contemporary interest in materials science and engineering.

Structural colors are advantageous because they are photo- and chemo-stable, more environmentally conscious, and can achieve a wide range of hue, saturation, and brightness with a relatively tiny chemical library. Structural colors can provide a variety of types of output. Though angle-intolerant or angle-tolerant color is often required for consistent color perception, for example, in decoration, angle-variable color is desirable for certain other applications (e.g., luxury packaging, certain types of automotive pigments, anticounterfeiting, colorimetric sensing) to give a distinct, color-shifting appearance.

Recently, structural color designed from stratified layers has proven to be one of the most promising ways to achieve industrial level production due to relatively simple structures, as well as numerous coating methods available. These layered structural color pigments offer advantages such as long-term durability, brilliant coloration, environmental-friendly, and providing special visual effects (e.g., iridescence). However, how to systematically tune and enhance/optimize color chromaticity to create vivid and rich colors remains an open problem. Further, high-quality and brilliant structural colors have been successfully produced using vacuum-based deposition and patterning technology in recent decades. Nevertheless, the major obstacles of high production costs and limited scalability impede the commercialization of these vibrant color products.

Solution-processed structural colors, on the other hand, offer the benefits of cost-effectiveness, scalability, and versatility. Thus, it would be desirable to develop economical multilayer structures having predetermined color output that can exhibit maximum chroma or vivid colors, including iridescence when desired.

### SUMMARY

This section provides a general summary of the disclosure, and is not a comprehensive disclosure of its full scope or all of its features.

In certain aspects, the present disclosure relates to an optical device comprising a layer and more specifically, an ultra-low refractive index layer. The ultra-low refractive index layer comprises a porous dielectric material. The optical device also includes at least one additional layer comprising a second material.

In one aspect, the porous dielectric material is a metal oxide, metal nitride, or metal fluoride.

In one further aspect, the porous dielectric material is selected from the group consisting of: silicon dioxide (SiO₂), aluminum oxide (Al₂O₃), silicon nitride (Si₃N₄), magnesium fluoride (MgF₂), and combinations thereof.

In one aspect, the porous dielectric material is a metal oxide, metal nitride, or metal fluoride deposited via a glancing angle deposition (GLAD) process and selected from the group consisting of: silicon dioxide (SiO₂), aluminum oxide (Al₂O₃), silicon nitride (Si₃N₄), magnesium fluoride (MgF₂), and combinations thereof.

In one aspect, the porous dielectric material comprises silicon dioxide (SiO₂).

In one further aspect, the porous dielectric material comprises silicon dioxide (SiO₂) aerogel.

In one further aspect, the porous dielectric material comprises silicon dioxide (SiO₂) deposited via a glancing angle deposition (GLAD) process.

In one aspect, the optical device generates an output having a predetermined range of wavelengths that displays angle sensitivity.

In one further aspect, the output displays iridescence.

In one aspect, the optical device generates an output having a predetermined range of wavelengths that displays angle sensitivity and wherein the output displays iridescence.

In certain aspects, the present disclosure further relates to an optical device comprising a layer, more specifically, a low refractive index layer that comprises a porous aerogel material. In certain aspects, the optical device may be a structural color optical device. The structural color optical device further comprises at least one additional layer comprising a second material.

In one aspect, the porous aerogel material comprises silicon dioxide (SiO₂).

In one aspect, the porous aerogel material has a porosity of greater than or equal to 95% by volume of open pores.

In one aspect, the porous aerogel material has a porosity of greater than or equal to 98% by volume of open pores.

In one aspect, the porous aerogel material comprises a plurality of open pores. A portion of the plurality of open pores are filled with a medium other than air.

In one aspect, the medium comprises a volatile organic solvent.

In one aspect, the porous aerogel material comprises a solvent, which may be taken up by the porous aerogel material, and is configured to change an optical response of the optical device.

In one aspect, the porous aerogel material further comprises a nanomaterial.

In one further aspect, the nanomaterial comprises gold nanoparticles.

In one further aspect, the nanomaterial comprises carbon nanotubes.

In one aspect, the porous aerogel material further comprises a dye molecule for optical absorption to modify the effective refractive index of the low refractive index layer.

In one aspect, the porous aerogel material further comprises carbon nanotubes configured for broadband absorption.

In one aspect, the porous aerogel material further comprises a nanomaterial.

In one further aspect, the low refractive index layer has a real part of refractive index (n) of less than or equal to about 1.1.

In one aspect, the low refractive index layer has a thickness of less than or equal to about 500 nm.

In one aspect, at least one additional layer is a second layer adjacent to a first layer—the low refractive index layer—and the second material comprises a dielectric material.

In one further aspect, the dielectric material is a high refractive index material.

In one aspect, the optical device is an assembly comprising at least three layers. The at least one additional layer is a second layer comprising the second material that is a first dielectric material and the assembly comprises the second layer, the first layer or the low refractive index layer, and a third layer comprising a third material comprising a second dielectric material.

In one further aspect, the assembly further comprises a fourth layer comprising a fourth material comprising a third dielectric material. The first dielectric material and the second dielectric material have a high refractive index and the third dielectric material has a low refractive index, so that the low refractive index layer is a first low refractive index layer and the fourth layer is a second low refractive index layer. The assembly defines a high index-low index-high index-low index configuration arranged in a multilayer stack comprising the second layer, the at least one additional layer, the third layer, and the fourth layer.

In one aspect, the at least one additional layer is a second layer adjacent to the low refractive index layer and the second material comprises a metal.

In one aspect, the optical device is an assembly comprising at least three layers. The at least one additional layer comprising the second material is a second layer and the assembly comprises the first layer or low refractive index layer, the second layer, and a third layer comprising a third material.

In one further aspect, the second material comprises a first metal and the third material comprises a second metal, wherein the assembly defines a metal-dielectric-metal configuration having the low refractive index layer is disposed between the second layer and the third layer.

In one aspect, the optical device is a structural color device further comprising a resonator cavity comprising a multilayer stack including: a first layer comprising a light absorbing material, a second layer comprising the low refractive index layer defining a first side and a second side, wherein the first side faces the first layer, and a third layer comprising a high refractive index material. The third layer is disposed on the second side of the second layer.

In one further aspect, the structural color device has a chromaticity “C” of greater than or equal to about 90.

In one further aspect, the resonator cavity generates an output having a predetermined range of wavelengths that displays angle sensitivity and iridescence.

In one further aspect, the structural color optical device serves as a colorant that generates an output having a predetermined range of wavelengths.

In one aspect, optical device produces structural colors via an output having a predetermined range of wavelengths that displays angle sensitivity and angle-dependent iridescence.

In one further aspect, the light absorbing material of the first layer is selected from the group consisting of: silicon (Si), germanium (Ge), titanium (Ti), silicon carbide (SiC), gallium nitride (GaN), gallium phosphide (GaP), zinc sulfide (ZnS), zinc selenide (ZnSe), chalcogenides, iron oxides, carbon black, carbon nanotubes (CNTs), colored polymers, and combinations thereof and the high refractive index material of the third layer is selected from the group consisting of: titanium oxide (TiO₂), zirconium dioxide (ZrO₂), cupric (I) oxide (CuO), hafnium dioxide (HfO₂), amorphous silicon (a-Si), germanium (Ge), ferric oxide (Fe₂O₃), vanadium pentoxide (V₂O₅) zinc oxide (ZnO), molybdenum trioxide (MoO₃), tantalum pentoxide (Ta₂O₅), niobium pentoxide (Nb₂O₅), tungsten trioxide (WO₃), zinc selenide (ZnSe), zinc sulfide (ZnS), and combinations thereof.

In one further aspect, the first layer, the second layer, and the third layer respectively have a maximum average thickness of less than or equal to about 500 nm.

In certain other aspects, the present disclosure relates to a device comprising a first layer or region comprising a porous aerogel material comprising silicon dioxide (SiO₂). The device also comprises at least one additional layer or region comprising a dielectric material or a metal. The at least one additional layer or region is adjacent to the first layer, whether on a first side or a second side of the first layer.

In one aspect, the porous aerogel material has a porosity of greater than or equal to 95% by volume of open pores.

In one aspect, the porous aerogel material has a porosity of greater than or equal to 98% by volume of open pores.

In one aspect, the porous aerogel material comprises a plurality of open pores, wherein a portion of the plurality of open pores are filled with a medium other than air.

In one further aspect, the medium comprises a volatile organic solvent.

In one aspect, the porous aerogel material further comprises a nanomaterial.

In one further aspect, the nanomaterial comprises gold nanoparticles.

In one aspect, the first layer has a real part of refractive index (n) of less than or equal to about 1.1.

In one aspect, the first layer has a thickness of less than or equal to about 500 nm.

In one aspect, the at least one additional layer is a second layer adjacent to the first layer that comprises the dielectric material comprising a high refractive index material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1F. FIG. 1A shows a schematic illustration of Snell's law in a thin film. FIG. 1B shows resonance wavelength shift with respect to incident angles (based on equation 1). FIG. 1C shows angle-dependent sensitivity based on equation 2 with refractive index (n) varying from 1.06 to 2.26. FIG. 1D shows a schematic of cavity resonance in a high-low-absorber (HLA) structural color film. FIG. 1E shows subtraction of resonant wavelength from perfect reflection results in cyan-magenta-yellow (CMY) color. FIG. 1F shows a schematic of effect of refractive index on color travel.

FIGS. 2A-2D. FIG. 2A shows a schematic of fabrication of a high-low-absorber (HLA) structural color film having an aerogel layer. Cross-sectional scanning electron microscopy (SEM) shows refractive index and percent void (open pores) of aerogels with refractive indices of 1.06 (FIG. 2B), 1.14 (FIG. 2C), 1.22 (FIG. 2D). All scale bars are 200 nm.

FIGS. 3A-3D show CIE diagrams and photos in insets of: FIG. 3A is a multilayer structure of 38 nm TiO₂/aerogel/Si and FIG. 3B is a multilayer structure of 15 nm Al/aerogel/Si at viewing angles from 8° to 65°. Photos were captured outdoors in sunlight through a polarizing lens. Angle-resolved reflection spectra of FIG. 3C of a multilayer structure of 38 nm TiO₂/aerogel/Si and FIG. 3D of 15 nm Al/aerogel/Si (right) from 8° to 65°.

FIGS. 4A-4D. FIG. 4A shows elemental mapping of a high-low-absorber (HLA) structural color with schematic profile of structure adjusted for blending and surface roughness. FIG. 4B shows atomic fraction depth profile of O, Si, and Ti in the HLA multilayer structure. FIG. 4C shows volume fraction depth profiles of TiO₂, SiO₂, and void calculated from adjusted fitting profile using EMA method. FIG. 4D shows a comparison between measured reflection spectrum and simulated reflection spectrum adjusted for blend and roughness.

FIG. 5A-5D. FIG. 5A shows reflection dip minima of an HLA incorporating a silicon dioxide aerogel from 8 to 65 degree viewing angles at a refractive index (RI) ranging from 1.06 to 1.22. FIG. 5B shows refractive index effect on δλ at viewing angles from 25 to 65 degrees as measured (dots) and calculated from Equations 3 and 4 (dotted lines, N=1, d=180 nm). FIG. 5C shows agreement between experimental (solid lines) and simulated (dashed lines) angle-resolved reflection spectra of aerogel-containing (RI 1.06) HLA. FIG. 5D shows agreement between experimental and simulated angle travel of the aerogel-containing (RI 1.06) HLA.

FIG. 6A-6C. FIG. 6A shows a CIE diagram and photos of an HLA multilayer structural color device having 25 nm TiO₂/340 nm gold nanoparticles (AuNP)-aerogel/Si at viewing angles from 8° to 65°. Photos were captured outdoors in sunlight. FIG. 6B shows angle-resolved reflection spectra of a multilayer structure of 25 nm TiO₂/340 nm AuNP-aerogel/Si from 8° to 65°. FIG. 6C shows reflection spectra of multiplayer structure of 15 nm Al/Aerogel (RI=1.07)/Si immersed in solvents (i.e., ethanol and toluene) and upon solvent removal.

FIGS. 7A-7F. FIG. 7A shows spin-coated aerogels with different refractive indices by changing TEOS concentration. FIG. 7B shows a cross-sectional SEM image of aerogels with a refractive index of 1.07, 1.14 and 1.23 (from left to right). FIG. 7C shows photographs of increasing viewing angle from 0 to 60°. FIG. 7D shows angle-resolved reflection spectra. FIG. 7E shows corresponding CIE diagram of 15 nm Al/Aerogel (n=1.07)/Si film at various angles showing a large color change. FIG. 7F shows reflection spectra of 15 nm Al/Aerogel (n=1.07)/Si immersed in solvents (i.e., ethanol and toluene) and upon solvent removal.

FIGS. 8A-8E. FIGS. 8A and 8B show S-Polarized Transmittance and S-Polarized Reflectance for a metal-insulator-metal structure shown in FIG. 8C that comprises an ultra-low index I layer and thus exhibits strong angle-dependent transmission and reflection behavior according to certain aspects of the present disclosure. FIGS. 8D and 8E show color maps detailing a change with respect to angle of incidence for both s-polarized light (FIG. 8D) and p-polarized light (FIG. 8E).

FIGS. 9A-9H. FIGS. 9A-9B and 9D-9E show S-Polarized Transmittance and S-Polarized Reflectance for two high refractive index (H)-low refractive index (L)-high refractive index (H) structures respectively shown in FIGS. 9C and 9F, where the low refractive index layer (L) comprises an ultra-low index layer and thus exhibits strong angle-dependent transmission and reflection behavior according to certain aspects of the present disclosure. FIGS. 9G and 9H show color maps detailing a change with respect to angle of incidence for both s-polarized light (FIG. 9G) and p-polarized light (FIG. 9H).

FIGS. 10A-10F. FIG. 10A shows UV-Vis absorption spectra of rhodamine 6G (R6G), brilliant green (BG) and methylene blue (MB). FIGS. 10B-10E show extracted refractive index of dye-doped titanium dioxide (TiO₂), with 1 wt. % total dye content dissolved in the precursor solution. More specifically, FIG. 10B shows R6G, FIG. 10C shows MB, FIG. 10D shows BG and MB, and FIG. 10E shows R6G and BG. FIG. 10F shows refractive index of an R6G doped TiO₂ layer, with R6G concentration varying from 0.02 wt. % to 5 wt. % in the precursor solution.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In various aspects, the present disclosure contemplates a structural color optical device that includes a low refractive index layer. By “low refractive index” layer (e.g., L layer), it is meant the layer exhibits a low refractive index, for example, having a real part of the refractive index (n) of less than or equal to about 2, optionally less than or equal to about 1.75, optionally less than or equal to about 1.5, optionally less than or equal to about 1.4, optionally less than or equal to about 1.3, and optionally less than or equal to about 1.25. In certain aspects, the optical device may comprise an “ultra-low refractive index” material or layer, which exhibits an ultra-low real part of the refractive index (n) of less than or equal to about 1.35, optionally less than or equal to about 1.25, optionally less than or equal to about 1.2, optionally less than or equal to about 1.15, optionally less than or equal to about 1.1, an in certain aspects, optionally less than or equal to about 1.06. As such, a low refractive index layer, as referred to herein, thus encompasses an ultra-low refractive index layer and any reference to a low refractive index herein may also be understood to refer to an ultra-low refractive index.

For example, in accordance with certain aspects of the present disclosure, the low refractive index layer may comprise a porous aerogel material. While the lowest refractive index of a naturally-occurring, solid dielectric is close to 1.37 (i.e., magnesium fluoride (MgF₂)), a highly porous dielectric material with an even lower refractive index is employed in the low or ultra-low refractive index layer of the optical device according to certain aspects of the present disclosure. In certain aspects, a highly porous material suitable for use in a low or ultra-low refractive index layer may comprise a dielectric material, such as a metal oxide, by way of example. For example, a highly porous dielectric silicon dioxide (SiO₂) aerogel can achieve ultralow-refractive index levels, for example, having n around 1.06, using either specialized physical vapor deposition methods or cost-effective solution-based manufacturing process. Thus, in certain aspects, an ultralow refractive index layer material has a refractive index (n) in the ranges of those described above, for example, less than or equal to about 1.35, optionally less than or equal to about 1.25, and in certain variations, optionally less than or equal to about 1.1, among other values. In certain aspects, the porous dielectric material is selected from the group consisting of: silicon dioxide (SiO₂), aluminum oxide (Al₂O₃), silicon nitride (Si₃N₄), magnesium fluoride (MgF₂), and combinations thereof. In certain further aspects, the porous dielectric material comprises silicon dioxide (SiO₂).

The achieved structural color may be highly iridescent and capable of tracing a near-closed loop in CIE color space. In accordance with certain aspects of the present disclosure, the structural color device may exhibit a relatively high chromaticity or chroma, as defined above as “C” where C=\sqrt{a*²+b*²}, where a* and b* are the coordinates in the CIE L*a*b* diagram characterizing the hue level along the red-green and yellow-blue directions/axes. The structural color device may have a chromaticity “C” of greater than or equal to about 90, optionally greater than or equal to about 95, optionally greater than or equal to about 100, optionally greater than or equal to about 105, and in certain variations, optionally greater than or equal to about 110.

By tuning the refractive index, thickness, and geometry of the low-index layer (e.g., aerogel layer), the reflection dip's shape is controlled, therefore producing a wide range of vivid and iridescent colors. In certain aspects, light generated (e.g., reflected) from the structural color device exhibits a peak range of wavelengths as an output corresponding to a hue or desired color. In the visible range of electromagnetic radiation, wavelengths in a range of about 625 nm to 740 nm are red; orange is at about 590 nm to about 625 nm; yellow is at about 565 nm to about 590 nm; green is at about 520 nm to about 565 nm; blue or cyan is at about 500 nm to about 520 nm; blue or indigo is at about 435 nm to about 500 nm; and violet is at about 380 nm to about 435 nm. Notably, as used herein, blue may encompass blue/cyan, blue/indigo, and violet. In certain aspects, the output 86 of electromagnetic radiation can have a wavelength in a range of greater than or equal to about 625 nm to less than or equal to about 740 nm for red; a range of greater than or equal to about 520 nm to less than or equal to about 565 nm for green; a range of greater than or equal to about 500 nm to less than or equal to about 520 nm for blue or cyan, and a range of greater than or equal to about 435 nm to less than or equal to about 500 nm for blue or indigo. Further, in certain aspects, the light outputted from structural color device 50 may be extra-spectral or a mixture of several different wavelengths. For example, magenta is an extra-spectral mixture of red (625 nm to 740 nm) and blue (435 nm to 500 nm) wavelengths. In certain aspects, the output 86 may appear white (reflecting all colors) or black (absorbing substantially all colors in the visible spectrum).

The external surface of the structural color device may be opaque to an observer. As noted above, the generated output from the optical device may be angle variable, meaning that the wavelength of light may vary depending on viewing angle and thus, may exhibit iridescence. In certain variations, the structural color may generate a predetermined range of resonance wavelengths that is angle variant and thus varies by greater than or equal to 40 nm at incidence angles ranging from 0° to 90° with respect to the device, optionally greater than or equal to 50 nm, optionally greater than or equal to 60 nm, optionally greater than or equal to about 70 nm, optionally greater than or equal to 80 nm, optionally greater than or equal to 90 nm, optionally greater than or equal to 100 nm, optionally greater than or equal to 110 nm, optionally greater than or equal to 120 nm, optionally greater than or equal to 130 nm, optionally greater than or equal to 140 nm, and optionally greater than or equal to 150 nm at incidence angles ranging from 0° to 90° with respect to the device.

A porous dielectric material may be highly porous, for example, optionally having a porosity of greater than about 75% to less than or equal to about 99.99% by volume with a plurality of pores or open voids formed within a body of the material. As used herein, the terms “pore” and “pores” refer to open voids of various sizes, having an average or median value, including both the internal and external pore diameter sizes. The pores may include so-called “macropores” (e.g., pores greater than about 50 nm diameter), “mesopores” (e.g., pores having diameter from about 2 nm to about 50 nm), “micropores” (e.g., pores having diameter of less than about 2 nm), and “nanopores” that generally overlap with microporous, mesoporous, and macroporous categories having pores with diameters between about 2 nm and about 100 nm). In certain aspects, the plurality of pores may include a plurality of internal pores and external pores that are open to one another so as to create continuous flow paths or channels through the material body. While the term “aerogel” is used herein, the plurality of pores or open voids may thus be filled with air or another medium or composition (e.g., gaseous, vapor, liquid, or semi-liquid/gel). In this manner, the body of the material may have a first refractive index and the medium(s) occupying at least a portion of the open volume of the pores may have a second refractive index that may together define an overall or cumulative refractive index of the porous material.

In certain variations, the porous dielectric material may have a porosity of greater than about 80% by volume, optionally greater than or equal to about 85%, optionally greater than or equal to about 90%, optionally greater than or equal to about 95%, optionally greater than or equal to about 97%, optionally greater than or equal to about 98%, and optionally greater than or equal to about 99% by volume. In certain aspects, the porosity of the porous material may be greater than or equal to about 95% to less than or equal to about 99.99% by volume, optionally greater than or equal to about 97% to less than or equal to about 99.98% by volume, and optionally greater than or equal to about 98% to less than or equal to about 99.98% by volume.

The optical device further includes at least one additional layer or region comprising a second material that is distinct from the porous low-index material. The at least one additional layer or region is adjacent to the porous low-index layer, for example, including either on a first side or a second side of the porous low-index layer. In various aspects, the layers may be one or more thin film layers. Notably, as will be described herein, the first layer (e.g., low refractive index layer), second layer (e.g., at least one additional layer), and optionally third or more additional layers may in fact themselves comprise multiple distinct layers (or films or coatings) that provide the desired “layer” or component properties in the assembly, for example providing a multilayer low refractive index and the like. In certain aspects, at least two layers, such as three or more layers may be disposed on a substrate and thus define a multilayer stack.

For example, the low refractive index layer and the at least one additional layer may independently have a maximum average thickness of less than or equal to about 600 nm, optionally less than or equal to about 575 nm, optionally less than or equal to about 550 nm, optionally less than or equal to about 525 nm, optionally less than or equal to about 500 nm, optionally less than or equal to about 475 nm, optionally less than or equal to about 450 nm, optionally less than or equal to about 425 nm, optionally less than or equal to about 400 nm, optionally less than or equal to about 375 nm, optionally less than or equal to about 350 nm, optionally less than or equal to about 325 nm, optionally less than or equal to about 300 nm, optionally less than or equal to about 275 nm, optionally less than or equal to about 250 nm, optionally less than or equal to about 225 nm, optionally less than or equal to about 200 nm, optionally less than or equal to about 175 nm, optionally less than or equal to about 150 nm, optionally less than or equal to about 125 nm, optionally less than or equal to about 100 nm, optionally less than or equal to about 75 nm, and in certain variations, optionally less than or equal to about 50 nm.

In certain variations, each of the low refractive index layer and at least one additional layer may respectively have an average thickness of greater than or equal to about 2 nm to less than or equal to about 600 nm, optionally greater than or equal to about 5 nm to less than or equal to about 600 nm, optionally greater than or equal to about 10 nm to less than or equal to about 600 nm, optionally greater than or equal to about 15 nm to less than or equal to about 500 nm, optionally greater than or equal to about 20 nm to less than or equal to about 500 nm, and in certain variations, optionally greater than or equal to about 25 nm to less than or equal to about 500 nm.

In certain variations, the low refractive index layer comprising a porous dielectric material, such as an aerogel, may have a thickness of greater than or equal to about 40 nm to less than or equal to about 600 nm.

In certain variations, the layers may be selected to have a high index contrast between the low refractive index layer comprising a porous aerogel material and the at least one additional layer. For example, a difference in the refractive indices (n_{H}−n_{L}), where n_{H} is refractive index of the higher refractive index material and n_{L} is the refractive index of the lower refractive index material, is greater than or equal to about 0.5, optionally greater than or equal to about 1, optionally greater than or equal to about 1.5, and in certain aspects, optionally greater than or equal to about 2. Stated in another way, a difference in the refractive indices of the low refractive index layer and the one or more additional layers is substantial, for example, the refractive index contrast is at least about a 40% difference between the low refractive index and a relatively high refractive index ((n_{H}−n_{L})/n_{L}), optionally a refractive index contrast between the low refractive index layer comprising a porous dielectric material and a relatively high refractive index layer is greater than or equal to about 60%, optionally greater than or equal to about 80%, optionally greater than or equal to about 100%, optionally at least about a 150% difference, and in certain aspects, optionally at least about a 200% difference. Thus, the materials selected for the one or more additional layers that serve as a high refractive index layer (e.g., H layer) provide such a high refractive index contrast. In certain variations, the at least one high refractive index layer (e.g., H layer) has a real part of a refractive index of greater than or equal to about 1.5, optionally greater than or equal to about 2, optionally greater than or equal to about 2.5, optionally greater than or equal to about 3, optionally greater than or equal to about 3.5, and optionally greater than or equal to about 4.

The low refractive index material or ultra-low refractive index material may be a highly porous material dielectric material, such as a metal oxide, by way of example. In certain variations, the highly porous dielectric material may be a silicon dioxide (SiO₂) aerogel. For example, silicon dioxide (SiO₂) aerogel may be synthesized through sol-gel chemistry via a hydrolysis-condensation reaction. Hydrolysis of an organosilane precursor, such as tetramethylorthosilicate (TMOS) or tetraethylorthosilicate (TEOS), may be followed by condensation into silicon dioxide (SiO₂) nanoparticles, which further undergo agglomeration once the nanoparticles reach a critical size. As more SiO₂ nanoparticles join, a highly porous SiO₂ network is formed. Such a silicon dioxide (SiO₂) aerogel may have a porosity that provides an air volume occupancy of greater than or equal to about 95% up to 99% by volume, but can be even higher, for example, up to about 99.98%. Silicon dioxide (SiO₂) aerogel may be synthesized through sol-gel chemistry via a hydrolysis-condensation reaction. Hydrolysis of an organosilane precursor (for example, tetramethylorthosilicate (TMOS) or tetraethylorthosilicate (TEOS)) is followed by condensation into silicon dioxide (SiO₂) nanoparticles, which further undergo agglomeration once the nanoparticles reach a critical size. As more nanoparticles join together, a highly porous SiO₂ network is formed.

In other aspects, the low refractive index layer comprises a porous oxide material vapor deposited by the Glancing Angle Deposition (GLAD), which is a PVD deposition process where a thin film is created by placing a substrate at an angle to a direction of the material flux during deposition. Such a process may further include application of reduced pressures or vacuum during deposition. The porous structure of the film made by such vacuum deposition methods can be considered to be similar to an aerogel structure, due to a low density of the constituent material and high porosity.

In various aspects, an optical device may comprise a low refractive index layer that comprises a porous dielectric layer, as well as at least one additional layer. The porous dielectric layer may be an ultra-low index layer in certain variations. The low refractive index layer may comprise a porous aerogel, such as a silicon dioxide (SiO₂) aerogel. In other aspects, the low refractive index layer may be formed by a GLAD process that generates a highly porous dielectric material, such as a porous silicon dioxide (SiO₂). As will be described further herein, the optical device generates an output having a predetermined range of wavelengths that displays angle sensitivity. The optical device may produce strong angle-dependent spectral responses, including structural color devices that exhibit highly iridescent colors. In certain further aspects, the strong angle-dependent spectral responses, including reflection and transmission bands can vary sensitively with respect to angle of incidence. For example, in extreme cases, it is contemplated that the device can switch between transmission and reflection with varying incident angles.

Thus, the low refractive index or ultra-low refractive index material may include suitable low refractive index materials selected from the group consisting of: semiconductor oxides or nitrides, including silicon dioxide (SiO₂), silicon nitride (Si₃N₄), metal oxides and sulfides comprising zinc oxide (ZnO), cuprous oxide (Cu₂O), cupric oxide (CuO), hafnium oxide (HfO₂), molybdenum trioxide (MoO₃), tantalum pentoxide (Ta₂O₅), niobium pentoxide (Nb₂O₅), oxide tungsten trioxide (WO₃), zinc selenide (ZnSe), zinc sulfide (ZnS), aluminum oxide (Al₂O₃), magnesium fluoride (MgF₂), polymers, and combinations thereof. In certain variations, the low refractive index material for the second low refractive index layer (e.g., a second L layer) may be selected from the group consisting of: silicon dioxide (SiO₂), magnesium fluoride (MgF₂), and combinations thereof. As noted above, such materials create a highly porous structure, for example, an aerogel or a porous material formed by a GLAD deposition technique.

In certain other variations, the layers may be selected from a material comprising a metal selected from the group consisting of: silver (Ag), aluminum (Al), gold (Au), titanium (Ti), alloys, oxides, and combination thereof. A large difference between/strong refractive contrast can also be achieved between the low or ultra-low index dielectric material with such metallic materials.

Where the at least one additional layer is a high refractive index layer (e.g., H layer), it may comprise a high refractive index material selected from the group consisting of: semiconductors such as amorphous silicon (a-Si), germanium (Ge); metal oxides or sulfides such as titanium oxide (TiO₂), zirconium dioxide (ZrO₂), cupric (I) oxide (CuO), hafnium dioxide (HfO₂), ferric oxide (Fe₂O₃), vanadium pentoxide (V₂O₅) zinc oxide (ZnO), molybdenum trioxide (MoO₃), tantalum pentoxide (Ta₂O₅), niobium pentoxide (Nb₂O₅), tungsten trioxide (WO₃), zinc selenide (ZnSe), zinc sulfide (ZnS), cuprous oxide (Cu₂O), cupric oxide (CuO), iron oxides (such as, FeO, Fe₂O₃, and Fe₃O₄), and combinations thereof. In certain aspects, the high refractive index material selected from the group consisting of: titanium oxide (TiO₂), zirconium dioxide (ZrO₂), cupric (I) oxide (CuO), hafnium dioxide (HfO₂), and combinations thereof.

In certain aspects, the at least one additional layer, such as a high refractive index layer, may be applied in a deposition process over the porous aerogel layer, where a transitional region or gradient of compositions is defined therebetween (e.g., a blend layer that comprises different concentration gradients of the porous aerogel and the second material forming the at least one additional layer).

In certain aspects, the present disclosure provides a structural color device that includes a multilayer stack and may form a resonator cavity. In certain aspects, such a structural color device or assembly may provide high chroma and thus vivid color generation. The structural color with the resonator cavity including the porous aerogel may produce highly iridescent color.

For example, the at least one additional layer may further include a low refractive index layer with a low refractive index material distinct from the porous aerogel. For example, suitable low refractive index materials may be made by the fabrication techniques described above, including by modified sol-gel processing or GLAD, and selected from the group consisting of: semiconductor oxides or nitrides comprising silicon dioxide (SiO₂), silicon nitride (Si₃N₄), metal oxides and sulfides comprising zinc oxide (ZnO), cuprous oxide (Cu₂O), cupric oxide (CuO), hafnium oxide (HfO₂), molybdenum trioxide (MoO₃), tantalum pentoxide (Ta₂O₅), niobium pentoxide (Nb₂O₅), oxide tungsten trioxide (WO₃), zinc selenide (ZnSe), zinc sulfide (ZnS), aluminum oxide (Al₂O₃), magnesium fluoride (MgF₂), polymers, and combinations thereof. In certain variations, the low refractive index material for the second low refractive index layer (e.g., a second L layer) may be selected from the group consisting of: silicon dioxide (SiO₂), magnesium fluoride (MgF₂), and combinations thereof.

Additionally, or alternatively, the at least one additional layer may include a light absorption layer. In one variation, the light absorption layer (e.g., A layer) may comprise a light absorbing material that includes any material with absorptive properties of electromagnetic radiation with wavelengths in the visible light range. In certain variations, the light absorbing material may comprise an element selected from the group consisting of elements from Groups 2 to 16, for example, Groups 2, 4, and 13 to 16, or Groups 4 and 13 to 16, of the IUPAC Periodic Table. As referred to herein, “Group” refers to the Group numbers (i.e., columns) of the Periodic Table as defined in the current IUPAC Periodic Table, also known as Groups II to VI. Thus, in certain variations, the light absorbing material may include an element selected from Groups 2, 4, and 13 to 16, or more particularly, Groups 4 and 13 to 16, for example, transition metals selected from Groups IVb (IUPAC Group 4), like titanium (Ti), semiconductors and compounds thereof selected from Periodic Table Groups III to V (IUPAC Groups 13 to 15) of, including Group IV (IUPAC Group 14), such as silicon (Si), germanium (Ge), silicon carbide (SiC), Groups III to V (IUPAC Groups 13 to 15) semiconductor compounds, such as gallium nitride (GaN), gallium phosphide (GaP), Groups II to VI (IUPAC Groups 2 to 16) semiconductor compounds, such as zinc sulfide (ZnS), zinc selenide (ZnSe), other chalcogenides, iron oxides, and combinations thereof. Chalcogenides may include an element from Group VI (IUPAC Group 16) of the Periodic Table, including various sulfides, selenides, tellurides, and the like.

In certain variations, the light absorbing material that forms the first layer (e.g., A layer) may be selected from the group consisting of: silicon (Si), germanium (Ge), titanium (Ti), silicon carbide (SiC), gallium nitride (GaN), gallium phosphide (GaP), zinc sulfide (ZnS), zinc selenide (ZnSe), chalcogenides, iron oxides, carbon black, carbon nanotubes (CNTs), colored plastics or polymers, and combinations thereof. Colored plastics or polymers may include polyesters, such as polyethylene terephthalate (PET), polyethylene naphthalate or (poly(ethylene 2,6-naphthalate) (PEN), polycarbonates, polyacrylates and polymethacrylates, including poly(methylmethacrylate) (PMMA), poly(methacrylate), poly(ethylacrylate), siloxanes, like polydimethylsiloxane (PDMS), acrylonitrile butadiene styrene (ABS), and the like including pigments or dyes. In certain variations, the light absorbing material that forms the first layer (e.g., A layer) may be selected from the group consisting of: silicon (Si), germanium (Ge), titanium (Ti), oxides thereof, colored plastics, and combinations thereof.

As will be described further below, in certain variations, a multilayer stack includes at least one layer comprising a first composition comprising a light absorbing material (e.g., a semiconductor) that is disposed on a lower or bottom end of the structure (that can be abbreviated as “A” for absorber). At least a second layer comprising a second composition that includes a low refractive index material (that can be abbreviated as “L” for low index) is disposed along one side of the first layer (e.g., A layer). The second layer (L-layer) may comprise a porous aerogel material. At least a third layer comprising a third composition including a high refractive index material (that can be abbreviated as “H” for high index) is disposed along a second side of the second layer (e.g., L layer) opposite to the side facing the first layer (e.g., A layer). As was discussed above, the first layer, second layer, or third layer may in fact comprise multiple distinct layers (or films or coatings) that provide the desired “layer” or component properties in the assembly, for example providing a multilayer light absorber component, a multilayer low refractive index or high refractive index component, and the like. The multilayer stack that comprises at least three material layers may be disposed on a substrate.

Any known substrate can be used for the high chroma structural color device and may serve as a structural support. In certain aspects, the substrate may absorb visible light, radiofrequency electromagnetic waves, or other ranges of wavelengths. Suitable examples of substrates include an inorganic dielectric material, such as silicon, silicon dioxide (SiO₂), a glass-based substrate, a metal, or a polymer, by way of non-limiting example.

As will be described herein, in certain variations, the second layer (e.g., L layer) comprising the porous aerogel may be disposed adjacent to and in contact with the third layer (e.g., H layer). The second layer (e.g., L layer) may also be disposed adjacent to and in contact with the first layer (e.g., A layer) in certain variations. In alternative aspects, the multilayer stack may include a fourth layer comprising a high refractive index material that has an ultrathin thickness that is disposed between the first layer (e.g., A layer) and second layer (e.g., L layer). In alternative aspects, the multilayer stack may include H/L/H/L/H/L . . . H/L/H forming 1-D photonic crystal like structure. In alternative aspects, the multilayer stack may include the low-index material sandwiched between two thin metallic layers.

Thus, the present disclosure provides in certain variations a tri-layer based structure comprising a high-index/low-index/absorber (HLA) configuration for color generation. Such structural color optical devices can produce high chroma color with such layered structures. The tri-layer can be expanded to a four-layer assembly or stack for improved chroma. In the HLA structure, the absorptive loss only comes from the bottom absorber layer (the first “A” layer). The electric field is confined within a middle low refractive index layer (second “L” layer) due to the index contrast among the three layers that causes high reflection from the two outmost layers (in other words from the first “A” layer and the third “H” layer). Therefore, such a tri-layer structure can be considered a special, highly asymmetric Fabry-Pérot cavity. This Fabry-Pérot type tri-layer stack for subtractive structural color is able to fit the reflection spectra feature and predict the color chromaticity well even without taking the material dispersion into account. An inclusion of an ultrathin high index dielectric on top of the lossy bottom layer can further boost the cavity absorptive decay rate, which helps to finetune the color chroma. Both simulation and experimental results are presented in accordance with color chromaticity predicted by the temporal coupled mode analysis.

Thus, super-iridescent structural color is provided from a simple high-refractive index/low-refractive index/absorber (HLA) trilayer structure in certain variations of the present disclosure that are environmental-friendly and provide lasting color, thin-film interference. For example, such a high-refractive index/low-refractive index/absorber (HLA) tri-layer structural color uses SiO₂ aerogel as the low-RI dielectric material. Due to its high porosity, SiO₂ aerogel has many unique properties including ultra-low density (approximately 1 mg·cm⁻³), ultra-low refractive index, very high surface area, and very low thermal conductivity. Such a material enables aerogel usage in a wide range of potential applications including energy storage, optical coating, catalysis, thermal insulation, and the like. Even so, the incorporation of aerogel into a cavity structure as a dielectric spacer for structural color applications has not been contemplated. For the first time, a silicon dioxide (SiO₂) aerogel has been introduced as an ultra-low refractive index dielectric layer, for example, within a TiO₂/SiO₂/Si system asymmetric F-P cavity and its color performance is investigated. The ultra-low refractive index of aerogel is close to that of air (n of approximately 1.06). Thus, the color can travel a large arc on the CIE diagram upon angle variation.

In various aspects, the present disclosure also contemplates various other devices comprising a first layer or region comprising a porous aerogel material comprising silicon dioxide (SiO₂). The device further comprises at least one additional layer or region comprising a dielectric material or a metal. An optical material with an ultra-low refractive index close to that of air can enable a number of photonic applications. To illustrate an important few, when a low-index material is arranged into layered structure with a high index material to form the familiar 1-D photonic crystal structure, producing a defined band of light reflection. Using an ultra-low index material can significantly reduce the number of layers required, and can broaden a bandwidth of the reflection, e.g., forming a dielectric material based mirror. For example, one structure could be an alternating stack, such as a high index-low index-high index-low index. In one structure, a HLHLHL multilayer alternating stack where H is a high refractive index layer and L is a low refractive index layer, and at least one of the L layers is the porous aerogel material. In certain variations, each of the L layers are ultralow refractive index layers comprising the porous aerogel, like silicon dioxide (SiO₂) aerogel. By way of example, a few periods of such (HL)ₙH structures, where n=1, 2, or 3, can form a narrower transmission band or reflection band that will vary with the angle of light incidence.

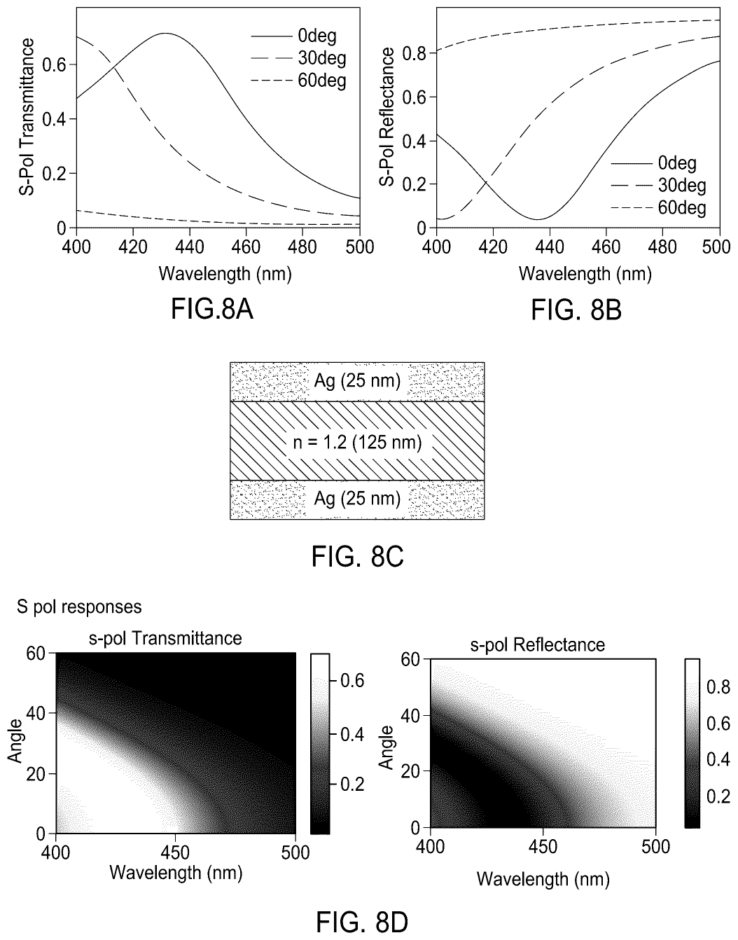

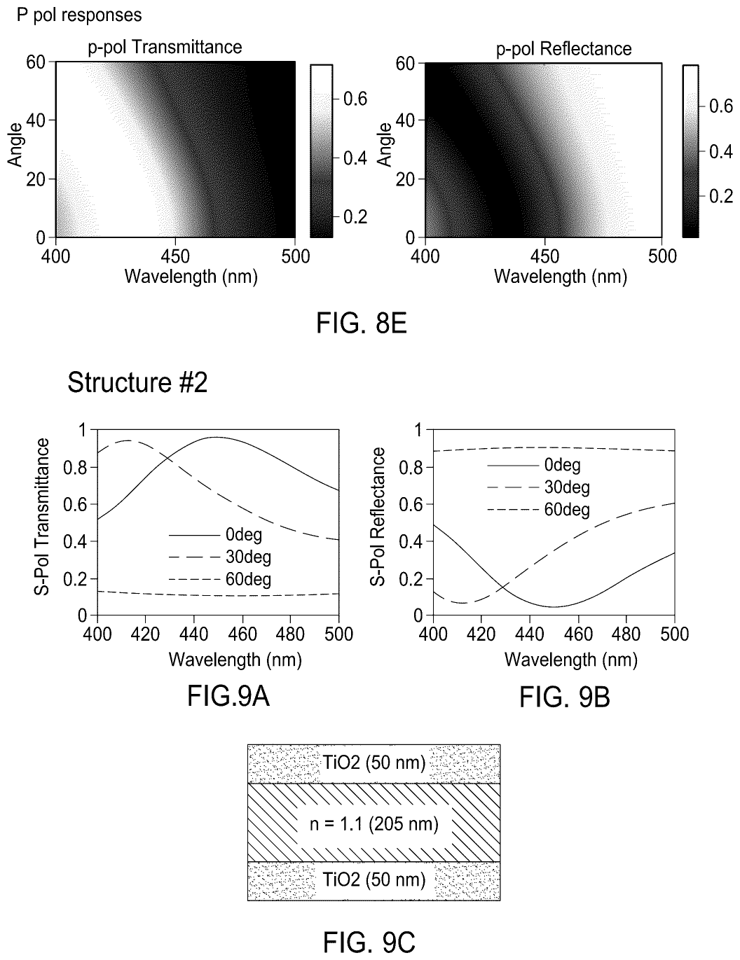

By way of non-limiting example, an optical device may be formed with a porous material that may include metal-insulator-metal (MIM) structures forming a transmission and reflection color filter. The insulator layer may comprise the ultra-low index porous material, such as porous silicon dioxide (SiO₂) aerogel. FIGS. 8A-8F show S-Polarized Transmittance and S-Polarized Reflectance for a metal-insulator-metal structure comprising an ultra-low index I layer. As shown in FIG. 8C, a middle low index porous material, like silicon dioxide aerogel having a refractive index of about 1.2 and a thickness of about 125 nm is sandwiched between two silver layers, each having a thickness of about 25 nm. The middle low index porous material serves as an insulator disposed between two thin metal layers. This MIM structure exhibits strong angle-dependent transmission and reflection behavior. Color maps detail a change with respect to angle of incidence for both s-polarized light (FIG. 8D) and p-polarized light (FIG. 8E).

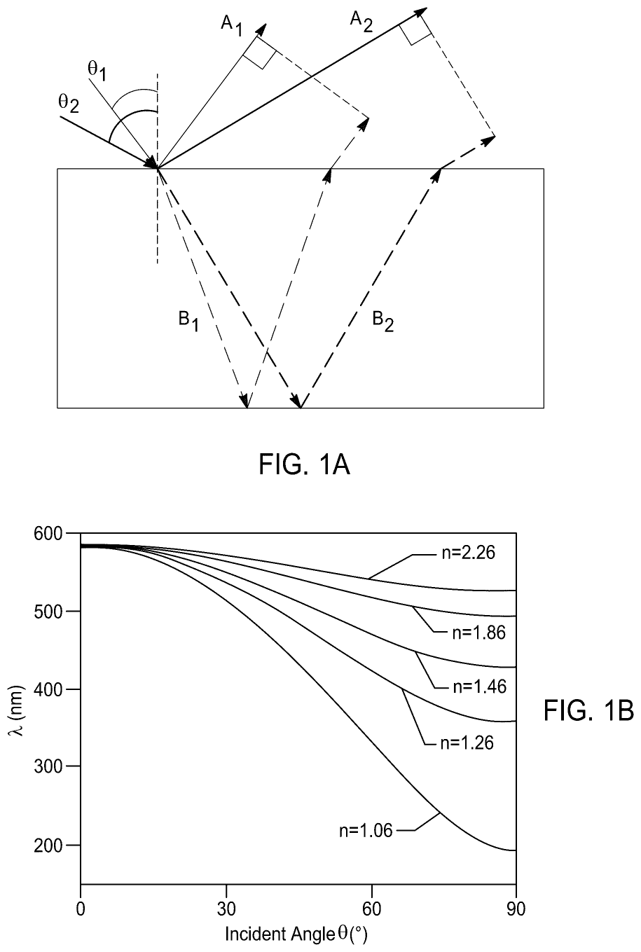

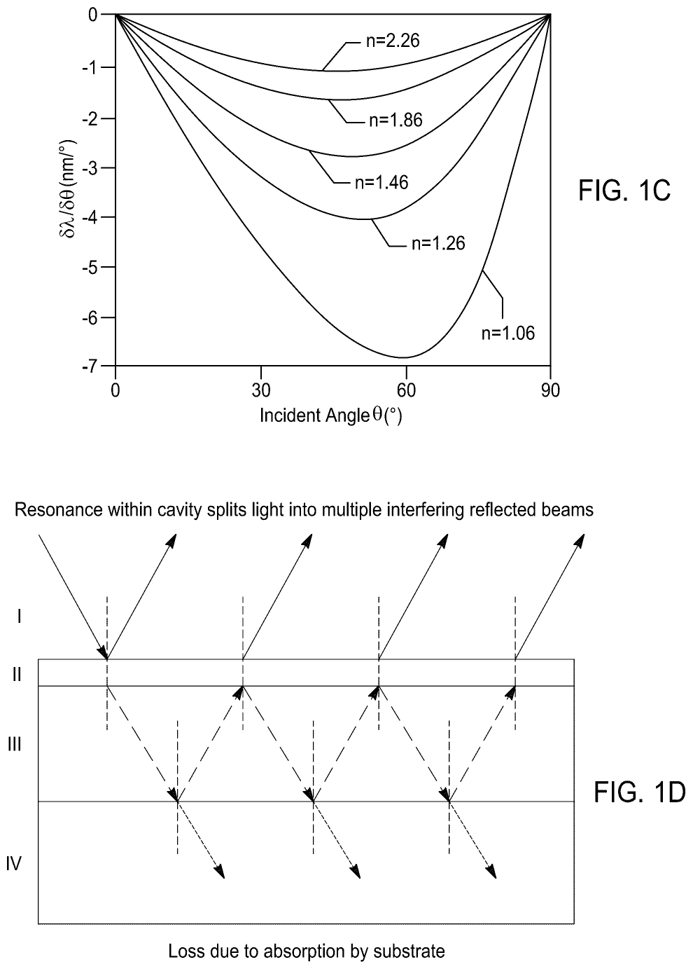

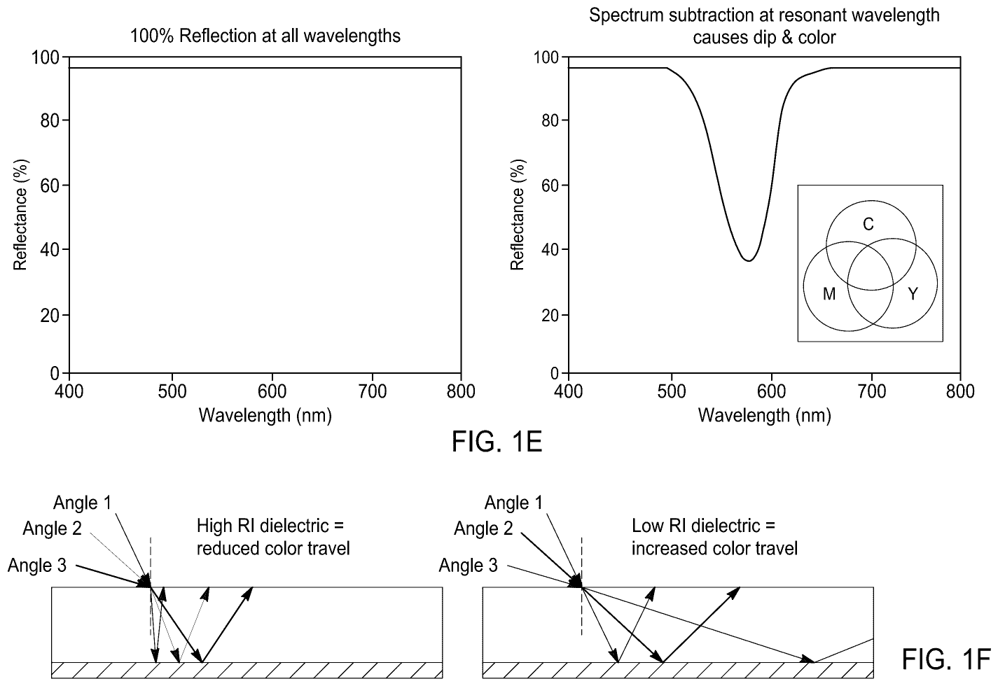

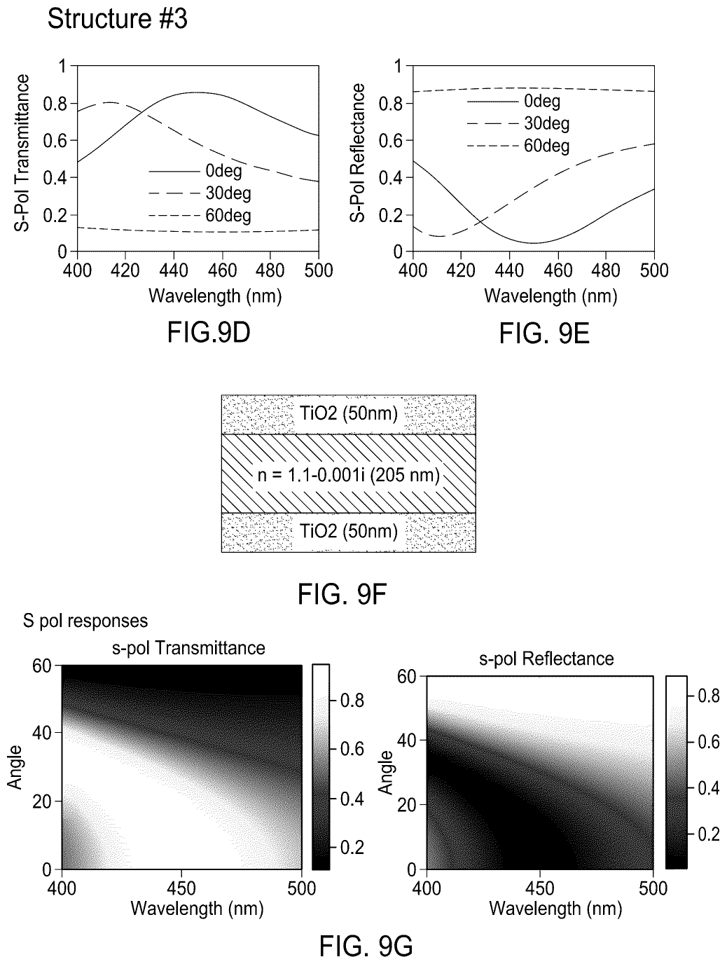

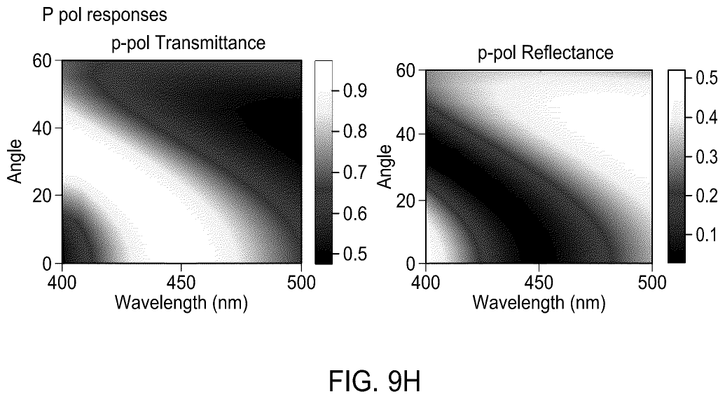

By way of further example, an optical device may be formed with a porous material in a multilayer stack that includes a high refractive index layer (H), a low refractive index layer (L), and a second high refractive index layer (H), which shows strong angle-dependent transmission and reflection behavior. The low refractive index layer (L) may comprise the ultra-low index porous material, such as porous silicon dioxide (SiO₂) aerogel. FIGS. 9A-9H show S-Polarized Transmittance and S-Polarized Reflectance for a HLH structure comprising an ultra-low index I layer. As shown in FIGS. 9C and 9F, a middle low index porous material, like silicon dioxide aerogel having a refractive index of about 1.1 (FIG. 9C) or 1.1-0.01i (FIG. 9D) with a thickness of about 205 nm is sandwiched between two titanium dioxide (TiO₂) layers, each having a thickness of about 50 nm. The non-zero k value of the low index dielectric in Structure #3 in FIG. 9F represents optical loss caused by light scattering by the porous structure or by material absorption. Color maps detail a change with respect to angle of incidence for both s-polarized light (FIG. 9G) and p-polarized light (FIG. 9H).

In another area, iridescent color-shift pigments have been used in some industrial applications, for example, for cosmetics and packaging. To achieve environmental-friendly and lasting color, thin-film interference can be used to generate structural color. When an ultra-low index material like a porous aerogel is used in such a structure, extreme color travel can be achieved producing highly iridescent colors not possible otherwise. Tuning the refractive index of such a material can control the optical response one desires. A broadband anti-reflection platform can be obtained when the refractive index of the layered structure forms a graded refractive index structure, with ultra-low index material (close to air) at the very top down to an index at the bottom of the stack that approaches that of the substrate. Such a broadband anti-reflection platform can be used for numerous applications, ranging from an astronomical telescope, to higher efficiency solar cells, photodetectors, to everyday display applications. The ultralow refractive index material comprising a porous aerogel can serve to create devices that can achieve extreme angle dependence. Potential applications include iridescent color coatings, anticounterfeiting devices, and colorimetric biosensors, by way of non-limiting example.

By way of background, structural colors from thin film interference can be understood by considering an optical path length difference between a directly reflected beam and a beam undergoing multiple reflections within the film, for example, as shown in FIGS. 1A-IF (assuming air as the incident medium). The optical path length difference between the initial reflected beam and the beam reflected through the film dictates which light wavelengths will constructively or destructively interfere, thereby generating color through interference effect. The refractive index of the film plays a very important role in determining the overall angle sensitivity

$$\frac{δ λ}{δ θ}$$

as a wider angle can decrease the path length difference, thereby blue-shifting the resonant wavelength. As shown in FIG. 1B, a very large shift in resonance wavelength is observed with a low refractive index, while the resonance wavelength hardly moves when the medium refractive index becomes high which is often exploited for angle-insensitive colors. In addition, the color change becomes more rapid at larger angles for low refractive index medium (FIG. 1C).

To enhance color perception, a thin film can be incorporated into a cavity comprising an optically thin high refractive index (RI) layer (layer II) atop a lower RI dielectric layer (layer III) and a partially absorbing and reflecting bottom layer (layer IV) in FIG. 1D. Air is labeled as I in FIG. 1D. This high-low-absorber (HLA) structure is a generalization of an asymmetric Fabry-Perot (FP) cavity, thus similar principles apply. The dielectric layer III forms a cavity where incident waves partially reflect and partially transmit at the cavity boundaries formed by the top high index (layer II) and bottom absorber layers (layer IV), so at the interfaces of II-III and III-IV shown in FIG. 1D. The perceived color is controlled by varying a thickness of the resonator cavity. Multiple beam interference produces a resonance condition where light of a selected wavelength is strongly absorbed by the bottom absorber layer, leading to subtractive color (FIG. 1E). The low RI dielectric material allows for a wide range of optical path length differences, resulting in highly angle-dependent colors. The purity of the subtractive color in the HLA structure depends on a balance of the absorption loss by the absorber material and the radiation loss of the cavity.

To allow for high optical path length variation, commercial iridescent color-shift pigments use TiO₂ (RI (n)=2.2) and SiO₂ (RI (n)=1.46) and other systems with a large refractive index difference. However, the lowest refractive index of a naturally occurring solid dielectric is close to 1.37 (i.e., MgF₂), which is still not significantly lower than SiO₂. In accordance with various aspects of the present disclosure, a dielectric aerogel can be employed, whose ultralow refractive index arises from high structural porosity. For example, an air volume occupancy in the porous aerogel is typically around 95%-99% by volume, but can be even higher, for example, up to about 99.98%. Silicon dioxide (SiO₂) aerogel may be synthesized through sol-gel chemistry via a hydrolysis-condensation reaction. Hydrolysis of an organosilane precursor (for example, tetramethylorthosilicate (TMOS) or tetraethylorthosilicate (TEOS)) is followed by condensation into silicon dioxide (SiO₂) nanoparticles, which further undergo agglomeration once the nanoparticles reach a critical size. As more SiO₂ nanoparticles join, a highly porous SiO₂ network is formed.

For producing an HLA structural color assembly, titanium dioxide is used as a high refractive index layer (TiO₂, RI (n) of approximately 1.8-2.4) or aluminum is used (Al, RI (n) of approximately 1.37 @ 632.8 nm) as a top reflector, and a silicon (Si) substrate as bottom absorber, on which the aerogel layer is deposited. This achieves highly iridescent structural color capable of tracing a near-closed loop in CIE color space. By tuning the refractive index, thickness, and geometry of the underlying structures, the reflection dip's travel is controlled, therefore producing a wide range of iridescent colors.

Refractive index tuning can also further be achieved by adding light absorbing materials to the layer, such as organic dyes. Thus, the porous aerogel material may further comprise a dye molecule for optical absorption to modify the effective refractive index of the low refractive index layer. Fine-tuning the spectrum of an optically thick dielectric layer is very challenging due to limitations from conventional deposition methods and the intrinsic broad absorption band of the dielectric material. Compared to lossy inorganics, organic dyes usually exhibit a much narrower absorption band, which allows local fine-tuning of the absorptive property within a specific spectrum range (i.e., within the dye absorption range). As a small molecule, the dyes are soluble in various solvents that can easily be determined by proper chemical modification. Thus, the refractive index of the low-index dielectric layer can be further tuned by incorporating in one or more dye molecules.

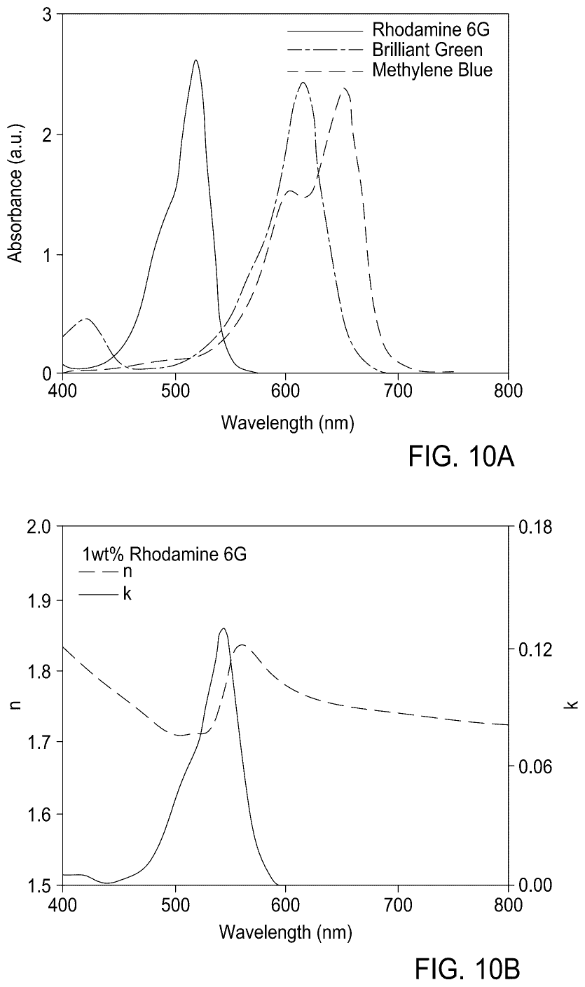

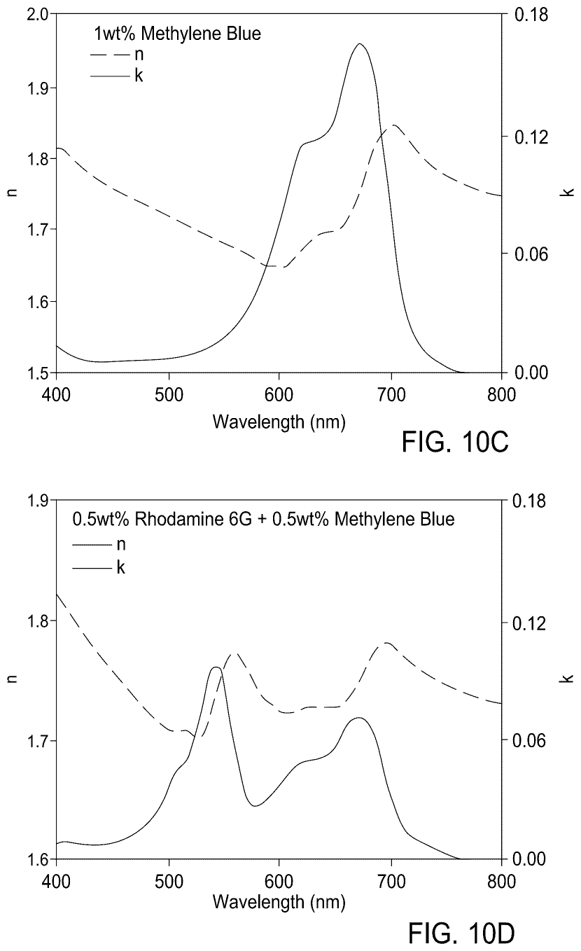

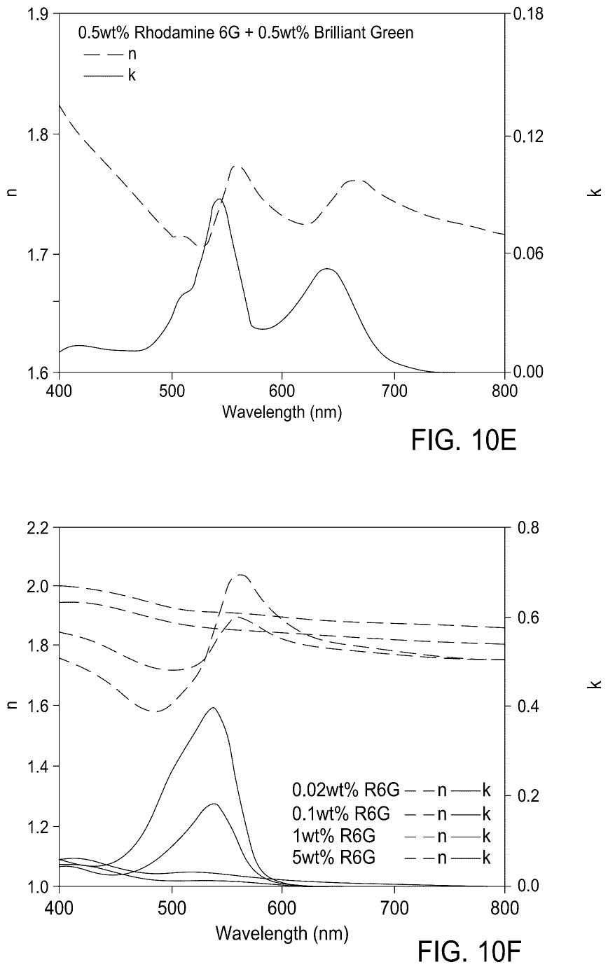

As an example, three dye molecules—rhodamine 6G (R6G), brilliant green (BG), and methylene blue (MB)—are selected for inclusion due to their high solubility in both water and ethanol, as well as their compatibility with the dielectric precursors tetraethyl orthosilicate (TEOS) and titanium (IV) tetraisopropoxide (TTIP). As shown in FIG. 10A, the three dyes show a narrow absorption peak with approximately 100 nm to 150 nm bandwidth at three different wavelengths. Hence, local modification of the refractive index becomes possible with a dye-doped dielectric layer (dD). The dD layer can be deposited using a typical dip-coating method. TiO₂ is selected as the matrix material because it has a different real part of refractive index than that of the dye. FIG. 10B gives the experimentally determined refractive index of the coated dD layer from 1 wt. % dye dissolved in the TiO₂ precursor solution. A quick comparison between the dyes' absorption spectra peaks and the imaginary part k of the coated dielectric reveals that the absorptive features of dyes have been integrated into the dielectric refractive index (FIGS. 10B-10C). The real part of the refractive index n also shows a distinctive anomalous dispersion feature due to the Kramers-Kronig relation (K-K relation) between n and k. Further combination of the dye molecules leads to more complex refractive index behavior (FIGS. 10D-10F), where the refractive index starts to oscillate across the spectrum due to the absorption of dyes at different wavelengths. The magnitude of the imaginary part of the RI can also be tuned by the dye concentration in the precursor solution. A continuous change of the imaginary refractive index has been shown in FIG. 10D with increasing R6G concentration.

Various embodiments of the inventive technology can be further understood by the specific examples contained herein. Specific Examples are provided for illustrative purposes of how to make and use the compositions, devices, and methods according to the present teachings and, unless explicitly stated otherwise, are not intended to be a representation that given embodiments of this invention have, or have not, been made or tested.

### EXAMPLES

Acetone (58.08 g/mol, ACS grade, Fisher Scientific, Hanover Park, IL), ethanol (46.068 g/mol, ACS grade, Fisher Scientific, Hanover Park, IL), hexanes (86.17 g/mol ACS grade, Fischer Scientific, Hanover Park, IL), toluene (92.14 g/mol, ACS grade, Fisher Scientific, Hanover Park, IL), Chlorotrimethylsilane (TCMS, 108.64 g/mol, puriss >99.0%, Sigma-Aldrich, St. Louis, MO), Tetraethyl orthosilicate (TEOS, 208.33 g/mol, 98% ACS grade, Sigma-Aldrich, St. Louis, MO), 3-aminopropyl triethoxysilane (APTES, 221.372 g/mol, Sigma-Aldrich, St. Louis, MO), gold (III) chloride trihydrate (HAuCl₄*3H₂O, 339.79 g/mol anhydrous basis, Sigma-Aldrich St. Louis, MO), sodium citrate dihydrate (HOC(COONa)(CH₂COONa)₂·2H₂O, 294.10 g/mol, ACS reagent, Sigma-Aldrich, St. Louis, MO), nitrogen gas (N₂, industrial grade, Metro Welding, Detroit, MI) were used as received. Milli-Q water with resistivity of >18.2 MΩ was used throughout. p-Si(100) wafers of 400 micrometers thickness were diced and used as substrate.

First, a substrate is prepared. Prior to coating, silicon wafers are cut into roughly 1″×1″ pieces then sequentially sonicated in acetone, ethanol, and water for 5 min with drying under N₂ flow between each bath.

Next, an aerogel is synthesized and deposited. A hydrolysis-condensation sol-gel reaction is used to prepare SiO₂ aerogel of RI (n) of 1.06 from TEOS. Into a base-cleaned and dry 100 mL glass media bottle, 11.1 mL ethanol (0.190 mol), 0.4 mL water (0.022 mol) and 11.1 mL TEOS (0.050 mol) were added in order under stirring. 0.5 mL 0.1 M hydrochloric acid (HCl) (0.0005 mol) was added slowly to adjust the pH to 3, resulting in a molar ratio of TEOS:EtOH:Water:HCl=1:3.8:1.1:0.001. The bottle was capped and left to stir at room temperature for 90 min to ensure full hydrolysis of TEOS. Condensation was initiated by adding another 102 mL of ethanol (1.749 mol) followed by 1.25 mL 28 wt. % ammonium hydroxide (NH₄OH, 0.010 mol) to give a molar ratio of TEOS:EtOH:Water:HCl:NH₄OH=1:38.8:3.6:0.001:0.004. After mixing, the resulting sol was capped and aged for 7-10 days in a 55° C. oven to complete hydrolysis, condensation, and aging, after which a wet porous, translucent gel is formed. The molar ratio of TEOS can be changed to increase the refractive index of the aerogel, adjusting ethanol accordingly to keep total volume consistent. Aerogel suspensions with RI of 1.14 and 1.23 were prepared by adding 1.5 (0.074 mol) and 2 times (0.099 mol) more TEOS respectively.

The wet gel was washed 3 times in ethanol at 55° C. at 1-hour intervals to remove residual unreacted material, followed by a solvent exchange in hexane at 55° C. for 1 hour. To resist network collapse during ambient pressure processing, hydrophobization of the wet gel was performed by submerging into 200 mL of 5 vol. % TCMS in hexane (0.079 mol TCMS) for 24 h at 55° C. Two additional hexane washes were performed at 55° C. at 1-hour intervals to removed unreacted TCMS. The gel was then redispersed into 200 mL hexane and subjected to pulsed tip sonication (Cole-Parmer 500W Ultrasonic Homogenizer) in cycles of 59 seconds on, 16 seconds off totaling 1 hour of pulse-on time. The gel was then vacuum filtered to remove large debris in the suspension. Drying over a molecular sieve can be performed to remove infiltrated water if necessary. The resulting aerogel suspension is mixed with an equal volume amount of toluene prior to spin-coating. Thickness control was achieved by diluting the aerogel stock suspension with 1:1 volume hexane:toluene solutions at different volume ratios.

The SiO₂ aerogel solution was drop-cast onto a substrate followed by spin coating (SETCAS LLC KW-4L Spin Coater) at 1,000 rpm for 60 seconds with 500 rpm·s⁻¹ ramp-up. The as-coated sample was baked on a 100° C. hot plate. Various thicknesses were achieved by spin-coating multiple layers of stock and dilute aerogel solutions. After the desired thickness was achieved, films were baked at 150° C. for 30 min in a convection oven to release residual film stress.

Gold nanoparticles are also synthesized as follows. Citrate anion-capped gold nanoparticles (AuNPs) were prepared by reduction from HAuCl₄ in aqueous media. Into a 250 mL double-necked round-bottomed-flask (double-necked RBF), 100 mL of 1 mM HAuCl₄ was added. The small neck was stoppered and a cold-water condenser was placed in the large neck. The solution was refluxed at 100° C. under vigorous stirring (about 800 RPM) for 15 minutes. Into the small neck, 10 mL of 38.8 mM sodium citrate solution was quickly added. Over the next 3 minutes, the solution changed from pale yellow to dark bluish gray to deep burgundy, indicating the growth of AuNPs. The solution was refluxed at 100° C. for another 15 minutes, then cooled to room temperature under continuous stirring, after which they were ready to use.

An aerogel is functionalized with gold nanoparticles as follows. Functionalization of an aerogel with gold nanoparticles is mediated by APTES. First, spin-coated aerogel films on Si wafers were baked in a furnace at 500° C. for 6 hours to burn away TCMS and other residual nonpolar organics, after which the films were submerged in a solution of 10 wt. % APTES in EtOH for 1 hour. The pieces were removed and thoroughly rinsed with EtOH and Milli-Q water, then dried under N₂ flow. The aerogel films were then immersed in AuNP solution for 1 hour to ensure adsorption of AuNPs to the aerogel, followed by rinsing with Milli-Q water to remove unadsorbed AuNPs.

A high-low-absorber (HLA) structure is formed, where Al or TiO₂ are deposited on the aerogel films by electron beam evaporation deposition (Evovac Evaporator, Angstrom Engineering). Initial TiO₂ deposition was performed at 5 Å·s⁻¹ to 5 nm thickness followed by deposition at 1 Å·s⁻¹ until desired thickness was reached. Al deposition was performed at 5 Ås⁻¹ until desired thickness was reached.

The HLA film structure is characterized as follows. Specular reflection spectra at normal incidence were measured using a thin-film measurement instrument integrated with a spectrometer (HR4000CG-UV-NIR, Ocean Insight) and a white halogen light source (HL-2000-FHSA, Ocean Insight). Angle-resolved specular reflection spectra were measured with a UV-Vis-NIR spectrometer (Lambda 1050, PerkinElmer Inc.) integrated with a Universal Reflectance Accessory. Diffuse reflectance (8°/d), specular+diffuse reflectance (8°/h), and transmission measurements were collected using the 150 mm InGaAs integrating sphere module (PerkinElmer, Inc.). Angle-resolved reflection spectra for s- and p-polarized light between 45-75° were collected on a spectroscopic ellipsometer (M-2000, J.A. Woollam Co. at angles between 45-75°; VASE®, J.A. Woollam Co. at angles between) 20-45°. Imaging and elemental distribution were performed using TEM/EDS (Thermo Fisher Spectra 300 Probe-Corrected S/TEM). The surface morphology was investigated using FE-SEM (SU8000, Hitachi) at 2 kV accelerating voltage. Aerogel and TiO₂ refractive indices were measured using spectroscopic ellipsometry (M-2000, J.A. Woollam Co.) and fit using CompleteEase 6.7. HLA structure models were constructed in CompleteEase 6.7 using measured data.

Simulated reflectance spectra and color appearance were calculated in MATLAB R2023b based on the transfer matrix method considering the aerogel as an effective medium. Optical dispersion of each layer was extracted from spectroscopic ellipsometer data as inputs. An adjusted model was fitted using the Bruggeman Effective Medium Approximation method with a gradual change in volume fraction to account for mixing as a function of depth.

Porosity and refractive index is controlled by silica precursor concentration. Aerogel is a highly porous structure with most of the space (open pores) filled with air. As described in detail above, aerogel synthesis from TEOS proceeds via hydrolysis-condensation. Under acidic conditions (pH of about 3), TEOS is hydrolyzed into Si(OH)ₙ(OEt)₄₋ₙ (1<n<4). Condensation into SiO₂ networks is triggered by raising the pH to slightly basic conditions (pH of about 8). First, SiO₂ particles are formed in solution and grow to a critical size, followed by assembly of these particles into a solvent-swollen SiO₂ network.

To remove solvent and form air voids without collapsing the delicate framework, fast extraction of the solvent is typically carried out with either critical point drying or freeze drying, thus yielding a bulk aerogel. However, it is neither practical nor feasible to coat a thin (sub-micrometer thick) aerogel film due to the lack of control over film thickness or uniformity. To enhance the rate of solvent removal during spin-coating and therefore enable processing at ambient conditions, aerogel particles are dispersed into a volatile solvent like hexane. However, using hexane alone will cause a thickness gradient along the radial direction of the film due to the uneven evaporation rate upon spinning. Therefore, toluene is introduced to lower the volatility of the solvent and achieve a uniform layer and thickness. However, simply processing in volatile solvents will still cause the aerogel network to collapse due to surface tension.

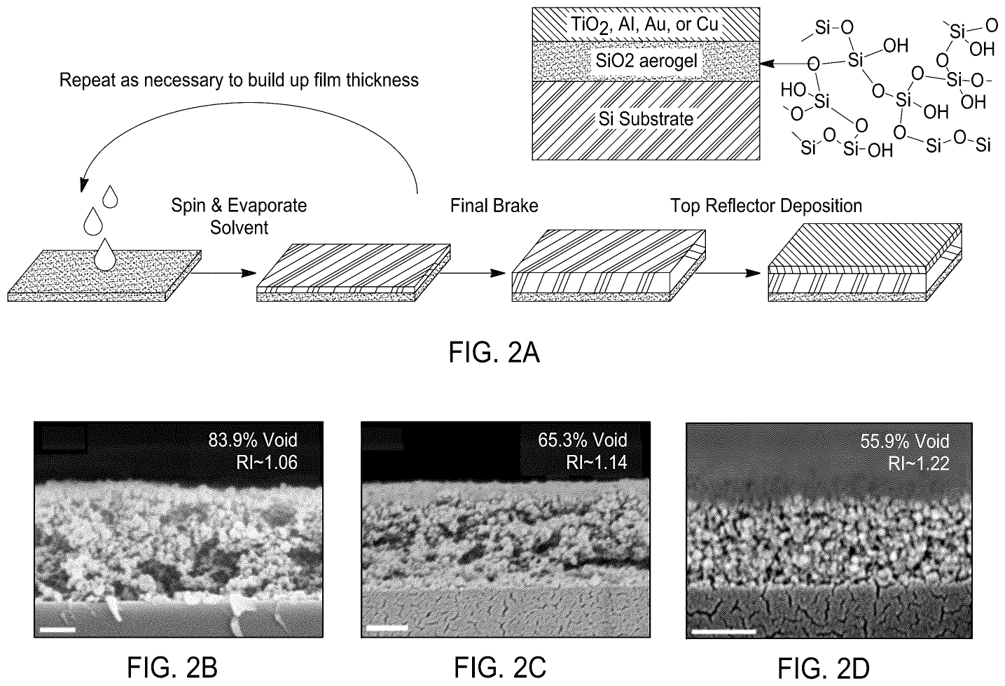

Thus, the aerogel is functionalized with chlorotrimethylsilane (TCMS) to allow for solvent removal without collapsing the aerogel pores. After solvent evaporation, the aerogel network microstructure is penetrated by hollow voids. The percentage of the aerogel layer made up by voids contributes to the low refractive index of the aerogel. The aerogel cavity layer thickness can be controlled from 40-600 nm thick through a combination of dilution, layering, and spin speed. Through the solution-based process given in the schematic in FIG. 2A, a low-index dielectric can be fabricated with a high degree of control over both refractive index and cavity thickness, for engineering super-iridescent structural color.

The cross-sectional SEM of fabricated aerogel films in FIGS. 2B-2D show increased network density as TEOS concentration is increased, while the void percentage and RI as calculated through spectroscopic ellipsometry is shown to decrease. This is corroborated by the increase in refractive index by ellipsometry with increasing TEOS concentration. The increasing refractive index is likely due to the denser SiO₂ network from an increased silica precursor concentration. Aerogel RI is controlled by porosity, which in turn is controlled by TEOS concentration. Through structural engineering, the refractive index of the aerogel dielectric is controlled and a refractive index as low as 1.06, close to that of air (RI=1) can be achieved.

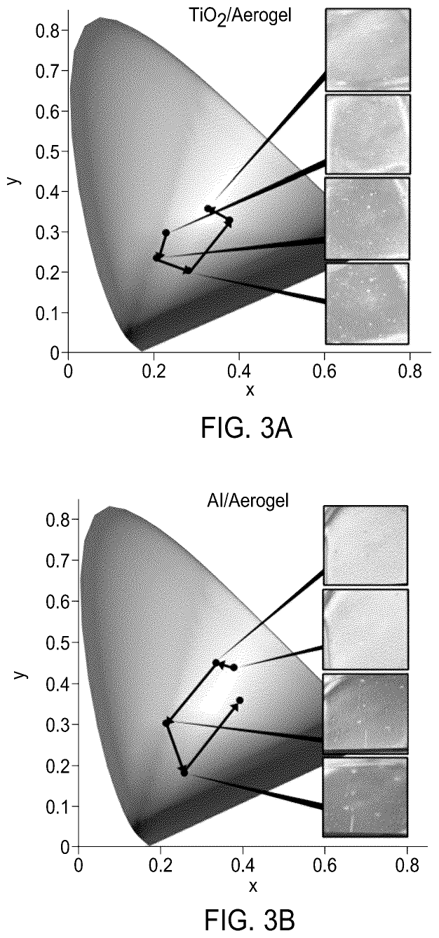

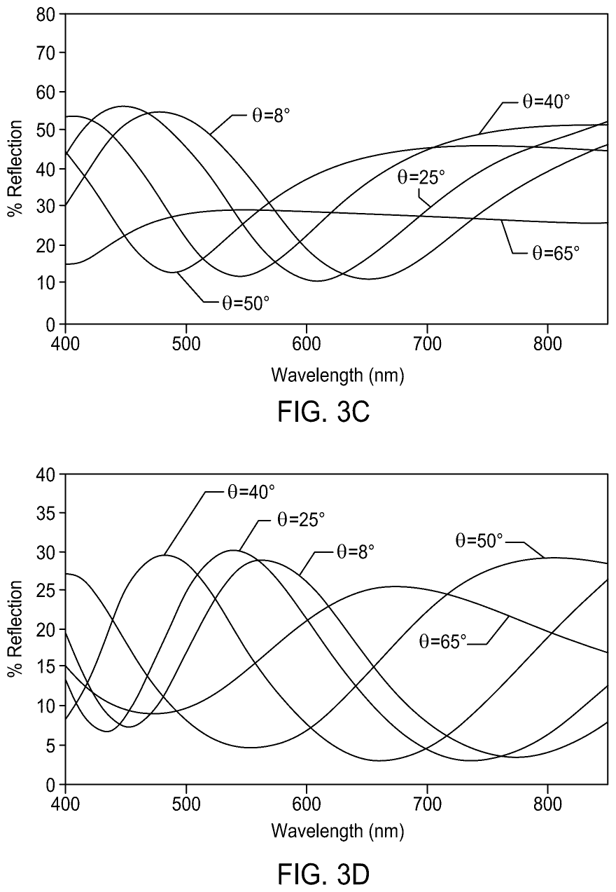

Iridescent structural color incorporating an aerogel material is formed and characterized as described herein. Due to the high porosity of the aerogel, deposition of the top reflector was done through e-beam deposition or nanoparticle deposition to minimize infiltration of the aerogel by the high RI layer. Two sets of samples were fabricated, with evaporated TiO₂ and Al as the topmost layer, respectively. Both the 38 nm TiO₂/Aerogel/Si and 15 nm Al/Aerogel/Si structures are capable of a near-complete circle on the CIE diagram between 8-65° viewing angles (FIG. 3A) and display distinct colors for the two types of samples. The color of the TiO₂/Aerogel/Si HLA transforms from cyan to blue to magenta to yellow at increasing viewing angles, while the color of the Al/Aerogel/Si HLA transforms from purple to pink to green to blue (FIG. 3B). The reflection dip minima in the corresponding spectra blue-shifts from 650 nm to 400 nm (TiO₂) or 540 nm into the UV (Al) with increasing viewing angle from normal (FIGS. 3C-3D). In either case, the solution-processable aerogel films help to create super-iridescent structural colors.

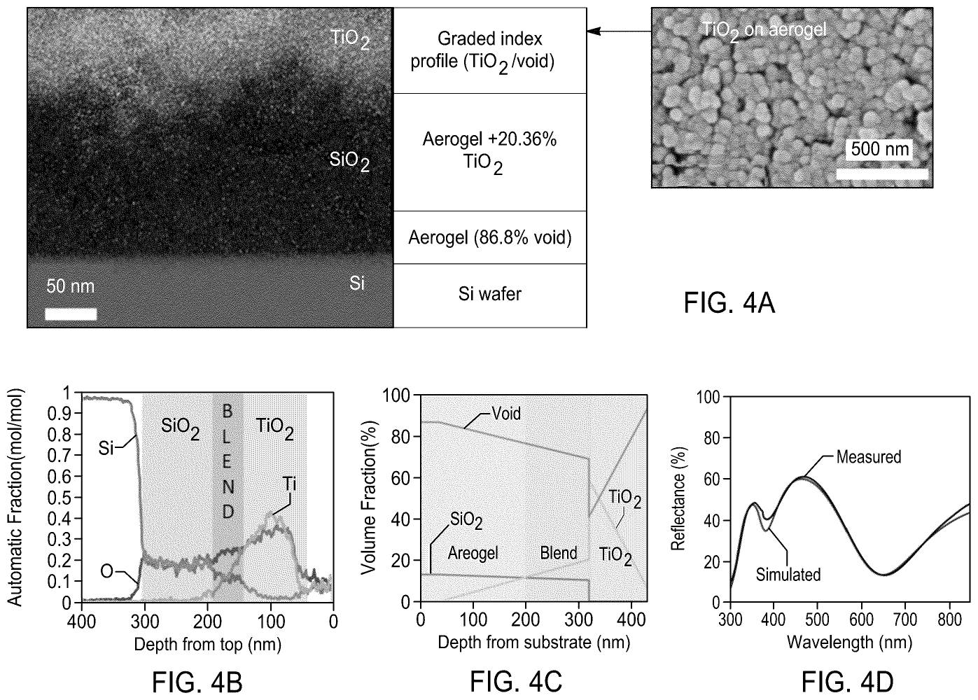

FIG. 4A shows a cross-sectional TEM and elemental analysis of e-beam deposited TiO₂ atop SiO₂ aerogel. The TiO₂ layer follows the contours of the rough aerogel layer and slightly infiltrates into the aerogel due to the porosity of the aerogel layer, shown by the transition region or blend layer in FIG. 4B. Compared to a pristine TiO₂ film on Si, TiO₂ follows the surface topology of the aerogel, resulting in a rough film (FIG. 4A). the scattering effect becomes more pronounced when forming a TiO₂/Aerogel/Si multilayer structure due to the roughened interface. The film shows a reflection max of about 50% and a minimum at 15% across all angles tested, and an iridescent structural color was successfully fabricated. The transition region/blend layer and scattering of the fabricated HLA are responsible for the deviation of the measured reflection spectra from the simulated reflection spectra based on uniform layer thickness and sharp interfaces.

To investigate the impact of the blend layer and HLA scattering, TiO₂ penetration, surface roughness, and fill fraction are considered in a simulation model. The updated model is shown in FIG. 4A, and accounts for partial penetration of TiO₂ into the aerogel layer, leading to the mixed layer observed in the elemental depth profile (FIGS. 4A-4B). This is consistent with the volume fraction depth profile in FIG. 4C calculated through the Effective Medium Approximation (EMA) method, showing that the aerogel and aerogel/TiO₂ blend layers are still highly porous. The EMA model is calculated by using Transfer Matrix Theory, and it was considered that each of layers were partially mixed with SiO₂, TiO₂, and air. To calculate EMA for the mixed layers, Bruggeman theory is implemented, which is used in the context of dielectric materials comprising a mixture of two or more different materials. In the model, the aerogel layer is designed to be mixed with air and SiO₂, and the aerogel layer is divided into several layers that are mixed with TiO₂ particles. The portion of TiO₂ in the aerogel layers gradually increases from 0% to 20.36%, and the thickness of bare aerogel layer is 33.2 nm. This shows that the TiO₂ particles penetrate the partial aerogel layer due to the porosity of the aerogel network.

At the interface between the aerogel and the TiO₂ layer, the porosity reduces to 41.3%, indicating a transition from the aerogel to TiO₂ (FIG. 4C). Due to the high surface roughness of TiO₂ (FIG. 4A), the porosity gradually increases again towards the surface of the film up to 94.1%. With these considerations, the adjusted model fits well to the experimental reflection spectrum (FIG. 4D); thus, the deviations from the ideal case can be attributed to partial TiO₂ penetration into the aerogel and surface roughness.

Aerogel index has strongest effect on reflection dip travel. Iridescence is an optical phenomenon in which hue changes with angle of observation. In the reflection spectrum of a subtractive structural color surface, this manifests as changes to the location of the reflection dip as the resonant wavelength changes. Notably, as viewing angle increases, the resonant wavelength decreases, causing the reflection dip to shift to shorter wavelengths.

Bragg's law can be used to understand the angle-dependent reflection spectrum behavior of a thin film structure (assuming air as the incident medium):

$$N λ = 2 nd {\vert 1 - {( \frac{1}{n} )}^{2} {sin}^{2} {θ}_{i} \vert}^{\frac{1}{2}} , \qquad Eqn . 1$$

where λ, n, d, and N are the resonant wavelength, the refractive index of the film, and layer thickness, and an arbitrary integer respectively (FIG. 1A). The angle-dependency can then be described as the change of resonance wavelength with respect to the incident angle:

$$\frac{δ λ}{δ θ} = {A [ {n}^{4} - {n}^{2} {sin}^{2} {θ}_{i} ]}^{- \frac{1}{2}} \qquad Eqn . 2$$

$$\text{where:}$$

$$A = - 2 Nnd sin ( θ ) {cos ( θ )}_{i} . \qquad Eqn . 3$$

According to Equation 2, the refractive index of the stratified medium plays a very important role in determining the overall angle sensitivity. As shown in FIG. 1B, a very large shift in resonance wavelength is observed with a low medium refractive index, while the resonance wavelength hardly moves when the medium refractive index becomes high. A further investigation on the angle sensitivity

$$\frac{δ λ}{δ θ}$$

reveals a higher sensitivity is achieved when the incident angle increases until a large angle of 50-60° is reached (FIG. 1C). In other words, the color change would become more rapid at larger angles for low refractive index medium. To determine the influence aerogel RI on the color travel, reflection spectra were collected between 8-65° and the dip minima position was recorded for each angle.

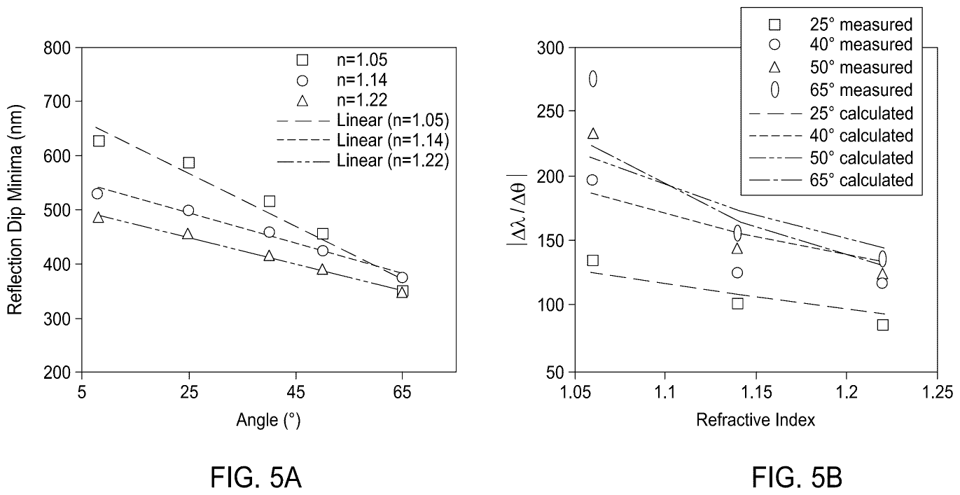

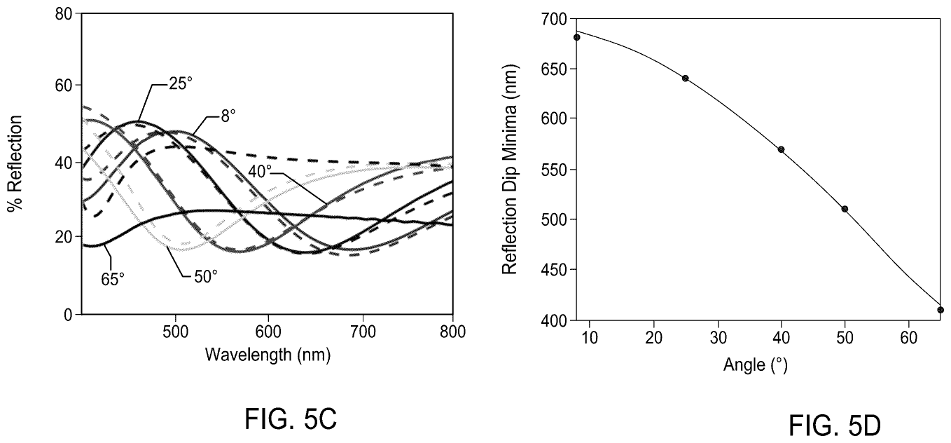

Aerogel refractive index has a significant effect on reflection dip minima shift. FIG. 5A plots the reflection dip minima wavelength against the measured viewing angle in degrees. A first-order approximation linear slope is fitted to the plot and compared across different refractive indices. By increasing the refractive index from 1.05 to 1.22, the slope of the minima wavelength versus angle plot decreases, corroborating the inversely proportional relationship between refractive index and

$$\frac{δ λ}{δ θ}$$

### in Equation 3. Changes in

$$\frac{δ λ}{δ θ}$$

with refractive index (FIG. 5B) and viewing angle (FIG. 5C) were calculated from the experimental data. The resulting trends match well to the trends of

$$\frac{δ λ}{δ θ}$$

versus refractive index and viewing angle calculated from Equations 3 and 4 and show

$$\frac{δ λ}{δ θ}$$

decreases with increasing refractive index and increases with increased viewing angle. This angle-dependent behavior is also observed in the model with roughness and blending accounted for. FIGS. 5D-5E show good agreement between the measured data and simulation, with rapid blue-shifting of resonance wavelength at increased viewing angles. Overall, as the viewing angle is increased from normal, the reflection dip minima travel to shorter wavelengths (blue-shifted), and this effect is strongly dependent on the aerogel refractive index.

Compared to aerogel refractive index, cavity thickness does not have much of an effect on the slope of the reflection dip minima versus angle plot. As thickness is increased, the reflection dip minima shift to longer wavelengths, only to shift to shorter wavelengths at increasing viewing angles from normal. The change is more notable as aerogel thickness is increased to 349 nm. At low film thickness (210 nm), fewer data points were collected due to the shift of the reflection dip into the UV range at 30 degrees from normal. TiO₂ thickness does not have much of an effect on reflection dip minima shift. These results demonstrate that the aerogel refractive index has the strongest effect on reflection dip minima shift and match the theoretical trends.

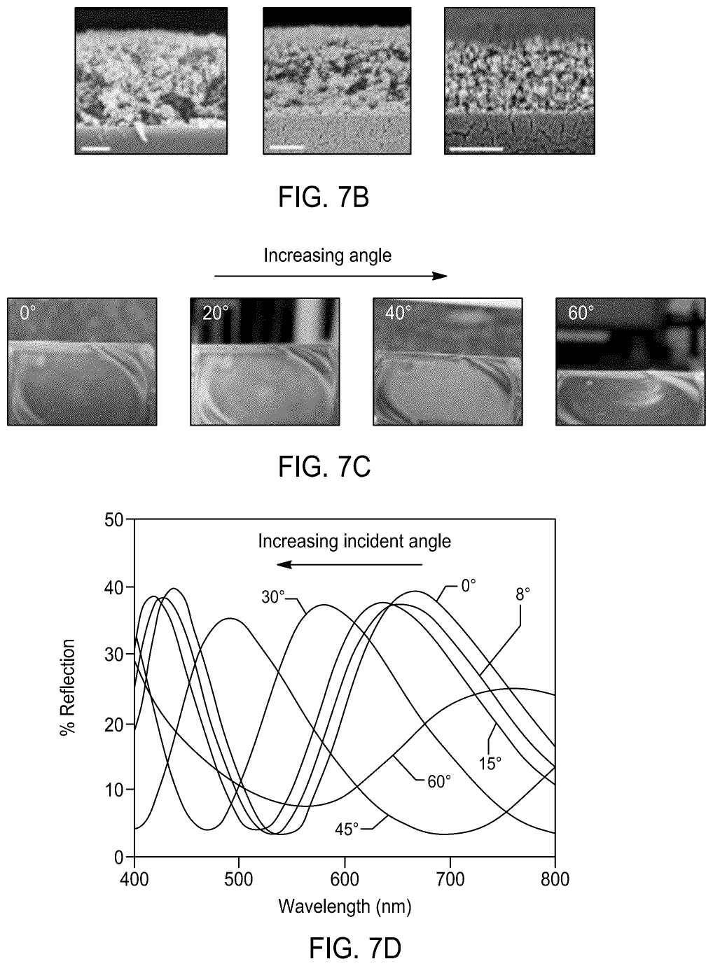

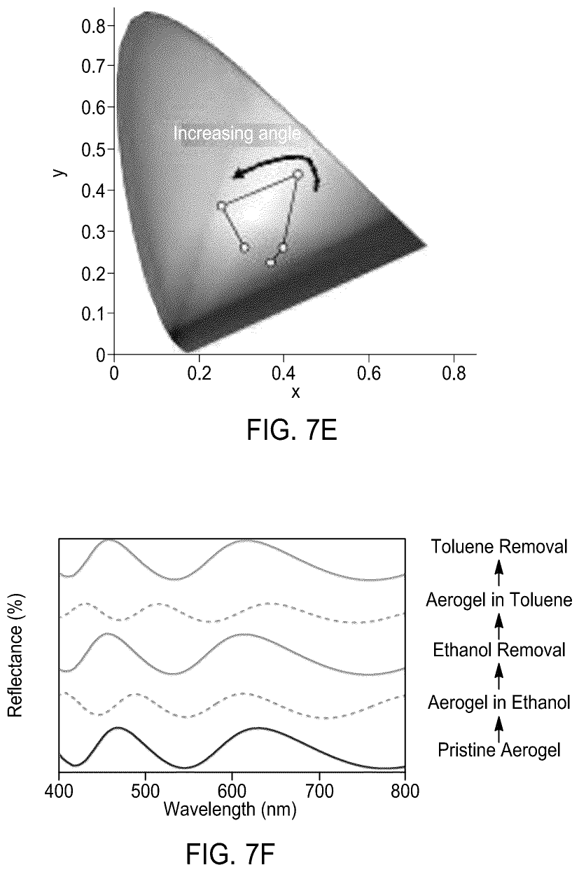

Structural color from multilayered stacks (Bragg stacks or F-P cavities) often show color iridescence, e.g., the color changes with viewing angle. A closer look at the Bragg's law indicates stronger angle dependency on the resonance wavelength when the refractive index of the cavity medium is lower. SiO₂ aerogel is employed as an ultra-low refractive index dielectric material in the F-P cavity and demonstrates its super-iridescent color performance. The preparation of SiO₂ aerogel follows that of sol-gel chemistry and uses a weak base (e.g., ammonia (NH₃)) to catalyze the condensation reactions. The TEOS molecules form small SiO₂ nanoparticles, and further undergo agglomeration once the nanoparticles reach a critical size. As more SiO₂ nanoparticles join, a SiO₂ framework forms and transforms the precursor solution into a porous gel. For the air void to form without collapsing the framework, a volatile solvent (e.g., hexane) is added to enhance the rate of solvent removal during spin-coating. SiO₂ aerogels with different refractive indexes are prepared with different TEOS concentrations. The resulting refractive index varies from 1.07 to 1.23 (FIG. 7A) with the increasing amount of TEOS being added. The low refractive index variation can be attributed to the porosity difference within the sample (FIG. 7B). The obtained tri-layer metal-dielectric-metal configuration having the low refractive index layer is disposed between the second layer and the third layer (MDM) structural color has 15 nm Al/SiO₂ aerogel/Si and shows a very iridescent color (FIG. 7C) upon angle variation. Reflection spectra have been measured from oblique incident angles from 0° to 60° with 15° interval. As shown in FIG. 7D, significant blue shifts in the resonance wavelength were observed under increased viewing angle from normal. A change in the visual appearance is more drastic with the lowest refractive index (n=1.07) aerogel, where color travels almost a closed trajectory on the CIE color space (FIG. 7E) upon angle variation. Such color iridescence is staggering where all three secondary colors (cyan, magenta, yellow) are reached within 60° angle variation.

Functional adjustments to refractive index can be made for various applications. Because the open pores/porous space in the aerogel gives rise to an ultra-low refractive index, these pores can also be filled with other mediums or compositions, making the structure a colorimetric sensor to a filled medium. The possibility of substituting the air void with other mediums or compositions, like ethanol or toluene, has been explored where a high-order resonance can be obtained along with a dramatic color change (FIG. 7F). The entire process is fully reversible with the removal of solvent and thus provides new insight into designing solvent/vapor-based colorimetric sensors.

Also, the aerogel HLA structure can be expanded upon through inclusion of plasmonic nanomaterials. In one aspect, the porous aerogel material further comprises a nanomaterial. In one aspect, the nanomaterial comprises gold nanoparticles. In other aspects, the In one aspect, the porous aerogel material further comprises carbon nanotubes configured for broadband absorption.

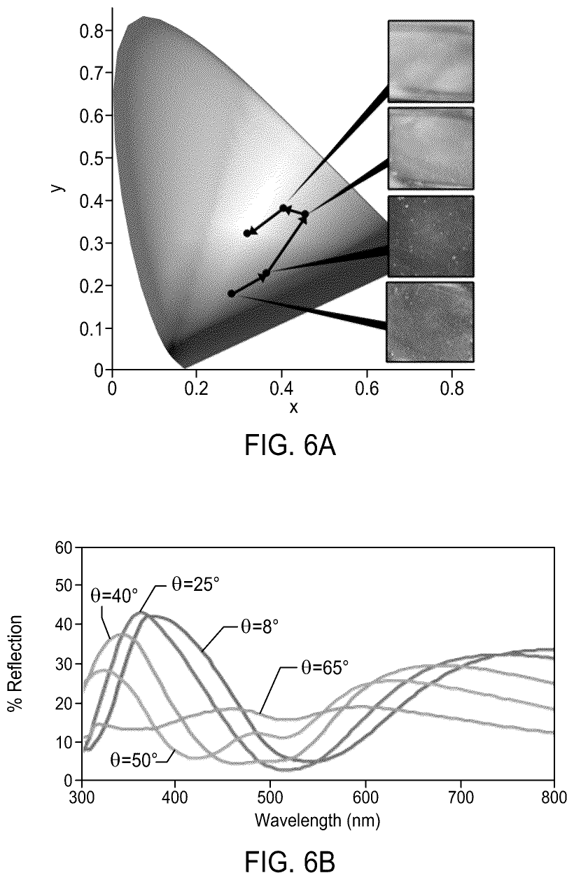

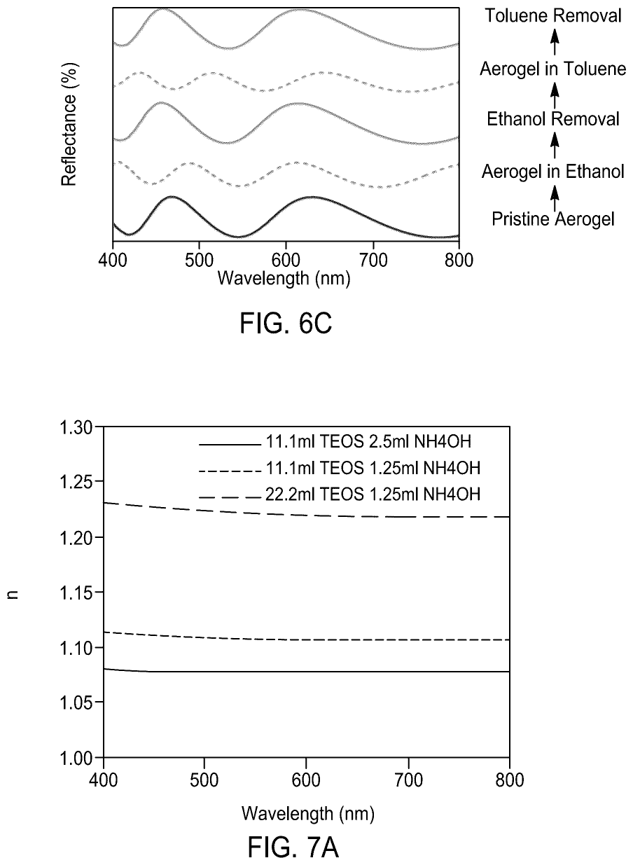

In this example, negatively charged gold nanoparticles (AuNPs) are partially deposited into the aerogel after functionalization with positively charged groups through ionic interactions. The resulting films and their reflection performance can be seen in FIGS. 6A-6B. Deposition of AuNPs does not negatively affect the color travel, but expands the range of achievable colors towards purple, orange, and yellow as seen in FIG. 6A. AuNPs also impart absorption around 500 nm to 530 nm, which can be seen as a dip in the reflection spectrum whose location remains constant even with changes to the viewing angle as seen in FIG. 6B. As the dip caused by cavity resonance blue-shifts with increased viewing angle, the dip caused by AuNP absorption remains relatively in place, leading to multiple dips observed in the reflection spectrum at high viewing angles and thus generation of unique colors such as orange at certain angles as seen in FIG. 6B. Thus, the shape of the reflection spectrum and therefore the observed color can be tuned by adding absorbing nanomaterials, for example, light absorptive nanomaterials, thereby expanding the range of achievable colors without sacrificing iridescence.

Replacing the pores with other mediums can also impart sensing abilities through changes in refractive index. Therefore, a drop of solvent can be cast onto the 15 nm Al/SiO₂ aerogel/Si film, where the solvent is quickly absorbed into the porous structure followed by a quick color change. As shown in FIG. 6C, a higher-order reflection peak shows up once the film gets soaked in ethanol. This can be understood as a surge in average refractive index once the air voids are replaced with ethanol (RI=1.36) while maintaining the overall thickness of the film, which leads to a larger optical path length and therefore a higher-order resonance. Once the ethanol is evaporated, the reflection spectrum recovers to its pristine value, indicating the porous structure has not been destructed. Similar behavior is observed with toluene (RI=1.50) but with a red shift in the higher order resonance as the higher refractive index of toluene gives an even longer optical path. Again, the reflection spectrum recovers to the original pristine film upon toluene removal. Thus, such porous aerogels can potentially serve as a colorimetric index sensor.

In summary, multilayer structures containing ultra-low index dielectric can produce strong angle-dependent optical responses. As an example, iridescent structural color using an ultra-low-index aerogel dielectric as a cavity and high-index materials, like TiO₂, as a top reflector in an HLA cavity have been successfully fabricated and characterized. Control over reflected color, reflection spectrum, electric field distribution, and color travel have been demonstrated through changes in aerogel thickness and refractive index. Such a porous aerogel network can further be functionalized by plasmonic nanomaterials through a simple solution process, which can be used as a chromatic index sensor. It is contemplated that solution fabrication of aerogel-incorporated materials can be used as pigments on a larger scale. The ultra-low index aerogel material can impart new possibilities otherwise unattainable in other optical elements.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An optical device comprising an ultra-low refractive index layer that comprises a porous dielectric material and at least one additional layer comprising a second material.

2. The optical device of claim 1, wherein the porous dielectric material comprises silicon dioxide (SiO₂) aerogel.

3. The optical device of claim 1, wherein the porous dielectric material is a metal oxide, metal nitride, or metal fluoride deposited via a glancing angle deposition (GLAD) process and selected from the group consisting of: silicon dioxide (SiO₂), aluminum oxide (Al₂O₃), silicon nitride (Si₃N₄), magnesium fluoride (MgF₂), and combinations thereof.

4. The optical device of claim 1, wherein the optical device generates an output having a predetermined range of wavelengths that displays angle sensitivity.

5. An optical device comprising a low refractive index layer that comprises a porous aerogel material and at least one additional layer comprising a second material.

6. The optical device of claim 5, wherein the porous aerogel material comprises silicon dioxide (SiO₂).

7. The optical device of claim 5, wherein the porous aerogel material has a porosity of greater than or equal to 95% by volume of open pores, wherein a portion of a plurality of open pores are filled with a medium other than air.

8. The optical device of claim 5, wherein the low refractive index layer has a real part of refractive index (n) of less than or equal to about 1.1.

9. The optical device of claim 5, wherein the porous aerogel material further comprises a dye molecule for optical absorption to modify the effective refractive index of the low refractive index layer.

10. The optical device of claim 5, wherein the porous aerogel material comprises a solvent configured to change an optical response of the optical device.

11. The optical device of claim 5, wherein the porous aerogel material further comprises a nanomaterial.

12. The optical device of claim 5, wherein the porous aerogel material further comprises a plurality of carbon nanotubes configured for broadband absorption.

13. The optical device of claim 5, wherein the optical device produces structural colors via an output having a predetermined range of wavelengths that displays angle sensitivity and angle-dependent iridescence.

14. The optical device of claim 5, wherein the structural color optical device is an assembly comprising at least three layers, wherein the at least one additional layer is a second layer comprising the second material that is a first dielectric material and the assembly comprises the second layer, the low refractive index layer, and a third layer comprising a third material comprising a second dielectric material.

15. The optical device of claim 14, further comprising a fourth layer comprising a fourth material comprising a third dielectric material, wherein the first dielectric material and the second dielectric material have a high refractive index and the third dielectric material has a low refractive index, so that the low refractive index layer is a first low refractive index layer and the fourth layer is a second low refractive index layer, wherein the assembly defines a high index-low index-high index-low index configuration arranged in a multilayer stack comprising the second layer, the at least one additional layer, the third layer, and the fourth layer.

16. The optical device of claim 5, wherein the at least one additional layer is a second layer adjacent to the low refractive index layer and the second material comprises a metal.

17. The optical device of claim 5, wherein the structural color optical device is an assembly comprising at least three layers, wherein the at least one additional layer comprising the second material is a second layer and the assembly comprises the low refractive index layer, the second layer, and a third layer comprising a third material, wherein the second material comprises a first metal and the third material comprises a second metal, wherein the assembly defines a metal-dielectric-metal configuration having the low refractive index layer is disposed between the second layer and the third layer.

18. The optical device of claim 5, wherein the structural color optical device further comprising a resonator cavity comprising a multilayer stack including:
a first layer comprising a light absorbing material;
a second layer comprising the low refractive index layer defining a first side and a second side, wherein the first side faces the first layer; and
a third layer comprising a high refractive index material, wherein the third layer is disposed on the second side of the second layer, wherein the first layer, the second layer, and the third layer respectively have a maximum average thickness of less than or equal to about 500 nm.

19. The structural color optical device of claim 18, wherein the structural color device has a chromaticity “C” of greater than or equal to about 90 and the resonator cavity generates an output having a predetermined range of wavelengths that displays angle sensitivity and iridescence, the light absorbing material of the first layer is selected from the group consisting of: silicon (Si), germanium (Ge), titanium (Ti), silicon carbide (SiC), gallium nitride (GaN), gallium phosphide (GaP), zinc sulfide (ZnS), zinc selenide (ZnSe), chalcogenides, iron oxides, carbon black, carbon nanotubes (CNTs), colored polymers, and combinations thereof and the high refractive index material of the third layer is selected from the group consisting of: titanium oxide (TiO₂), zirconium dioxide (ZrO₂), cupric (I) oxide (CuO), hafnium dioxide (HfO₂), amorphous silicon (a-Si), germanium (Ge), ferric oxide (Fe₂O₃), vanadium pentoxide (V₂O₅) zinc oxide (ZnO), molybdenum trioxide (MoO₃), tantalum pentoxide (Ta₂O₅), niobium pentoxide (Nb₂O₅), tungsten trioxide (WO₃), zinc selenide (ZnSe), zinc sulfide (ZnS), and combinations thereof.

20. A device comprising:
a first layer or region comprising a porous aerogel material comprising silicon dioxide (SiO₂); and
at least one additional layer or region adjacent to the first layer and comprising a dielectric material or a metal.
